(19) United States
(12) Patent Application Publication
(10) Pub. No.: US 2016/0330077 A1
(43) Pub. Date: Nov. 10, 2016

(54) WiFi VIRTUAL NETWORK SOLUTION

(71) Applicant: INTERDIGITAL PATENT HOLDINGS, Wilmington, DE (US)

(72) Inventors: Hao JIN, King of Prussia, PA (US); Carlos Jesus BERNARDOS, Madrid (ES); Juan Carlos ZUNIGA, Montreal (CA); Alexander REZNIK, Pennington, NJ (US)

(73) Assignee: INTERDIGITAL PATENT HOLDING, INC., Wilmington, DE (US)

(21) Appl. No.: 15/109,106

(22) PCT Filed: Jan. 8, 2015
(86) PCT No.: PCT/US15/10636

§ 371 Date: Jun. 29, 2016

Related U.S. Application Data
(60) Provisional application No. 61/924,944, filed on Jan. 8, 2014.

(51) Int. Cl. H04L 12/24; H04W 36/08; H04W 36/30; H04W 36/00

(52) U.S. Cl. CPC H04L 41/0816; H04W 36/0033; H04W 36/08; H04W 36/30; H04W 88/12

(57) ABSTRACT

User-specific virtual networks may be created within one or more physical wireless networks. For example, user-specific virtual networks may follow one or more wireless transmit/receive units (WTRUs) within a network, such as a WiFi network. A network controller may create and manage a plurality of Service Set Identifications (SSIDs), create virtual access points (APs), and assign virtual AP identifiers for a plurality of WTRUs. The network controller may request physical APs to create the virtual APs with the assigned virtual AP identifiers. Switches and routers may be configured so that each of the plurality of WTRUs has a user-specific virtual router and routing path to the user-specific virtual router. The network controller may reconfigure the switches and routers to maintain the user-specific virtual router and routing path as changes occur in the network.

### CROSS REFERENCE TO RELATED APPLICATIONS

This application is the U.S. National Stage, under 35 U.S.C. §371, of International Application No. PCT/US2015/010636 filed Jan. 8, 2015, which claims the benefit of U.S. Provisional Application No. 61/924,944 filed Jan. 8, 2014, the contents of which are hereby incorporated by reference herein.

### BACKGROUND

In the context of communication systems, software defined networking (SDN) is a paradigm where the control and data forwarding planes may be separated, thus allowing for quicker provision and configuration of network connections. With SDN, network administrators may program the control of the traffic in a centralized way, and may not need the actual data flows to be available at the centralized control units. OpenFlow is a standardized interface between the control and forwarding layers of the SDN architecture. OpenFlow may allow accessing and modifying the forwarding plane of network devices such as switches and routers.

Control And Provisioning of Wireless Access Points (CAPWAP) is a protocol that enables a centralized control in wireless networks. CAPWAP may be used to supplement OpenFlow by supporting operations that OpenFlow may not, such as access control, for example. CAPWAP may be technology agnostic and may have specific bindings for each considered access standard, including for example Institute of Electrical and Electronics Engineers (IEEE) 802.11 or “WiFi” standard. Radio configuration may be expressed in terms of management information base elements included in the standard(s), such as the operating channel or the transmission power, but may also be expressed in terms of the beacon interval or the contention parameters used by the medium access scheme. The CAPWAP protocol may enable a central wireless local area network (LAN) Access Controller (AC) to manage a collection of Wireless Termination Points (WTPs).

### SUMMARY

Methods and apparatus for creating user-specific virtual networks are described herein. For example, such user-specific virtual networks may follow one or more mobile nodes or wireless transmit/receive units (WTRUs) within a network or across multiple networks, including WiFi networks. A network controller may create and manage multiple dynamic Service Set Identifications (SSIDs) for a plurality of WTRUs. A network controller may identify a plurality WTRUs and may assign virtual access point (AP) identifiers to each of the plurality of WTRUs. The network controller may request physical APs to create virtual APs with the assigned virtual AP identifiers. The network controller may configure switches and routers so that each of the plurality of WTRUs has a user-specific virtual router and routing path to the user-specific virtual router.

If one of the plurality of WTRUs moves within the network, the network controller may request the physical APs create additional virtual AP(s) with the assigned virtual AP identifier corresponding to the at least one WTRU moving within the network. The network controller may reconfigure the switches and routers to maintain the user-specific virtual router and routing path as changes occur in the network. As a result, the WTRU may keep its IP address and level of service. In addition, there may be no service interruption during movement of the WTRU. Virtual network procedures for a Control and Provisioning of Wireless Access Points enabled network, a Software-Defined Networking (SDN) and/or OpenFlow Wireless enabled network, and/or a Control And Provisioning of Wireless Access Points (CAPWAP)+SDN/OpenFlow Wireless enabled network are described herein.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example RAN and an example core network of FIG. 1A;

FIG. 2 is a logical diagram of an example Software Defined Networking (SDN) architecture;

FIG. 3 is a system diagram of an example Control and Provisioning of Wireless Access Points (CAPWAP) Split Medium Access Control (MAC) architecture;

FIG. 4 is a system diagram of an example CAPWAP Local MAC architecture;

FIG. 5 is a system diagram of an example network architecture where a wireless transmit/receive unit (WTRU) is associated with a personalized cell;

FIG. 6 is a system diagram of an example virtual network management system and procedures to enable a virtualized WiFi network;

FIG. 7 is a signaling diagram of an example initial network attachment procedure;

FIG. 8 is a signaling diagram of an example intra-domain handover procedure;

FIG. 9 is a system diagram of an example CAPWAP network architecture;

FIG. 10 is a system diagram of an example SDN/Open Flow Wireless Network architecture;

FIG. 11 is a system diagram of an example CAPWAP+SDN/OpenFlow Wireless architecture;

FIG. 12 is a signaling diagram of an example CAPWAP-based, split MAC L2 network detection and initial attachment procedure;

FIG. 13 is a signaling diagram of an example CAPWAP-based, local MAC L2 network detection and initial attachment procedure;

FIG. 14 is a signaling diagram of an example SDN/OpenFlow Wireless L2 network detection and initial attachment procedure;

FIG. 15 is a signaling diagram of an example CAPWAP+SDN/OpenFlow Wireless, split MAC, L2 network detection and initial attachment procedure;

FIG. 16 is a signaling diagram of an example SDN/OpenFlow wireless, local MAC L2 network detection and initial attachment procedure;

FIG. 17 is a signaling diagram of an example CAPWAP-based, split MAC L3 network detection and initial attachment procedure;

FIG. 18 is a signaling diagram of an example CAPWAP-based, local MAC L3 network detection and initial attachment procedure;

FIG. 19 is a signaling diagram of an example SDN/OpenFlow Wireless L3 network detection and initial attachment procedure;

FIG. 20 is a signaling diagram of an example CAPWAP+SDN/OpenFlow Wireless, split MAC L3 network detection and initial attachment procedure;

FIG. 21 is a signaling diagram of an example CAPWAP+SDN/OpenFlow Wireless, local MAC L3 network detection and initial attachment procedure;

FIG. 22 is diagram of an example CAPWAP message following a CAPWAP Institute of Electrical and Electronics Engineers (IEEE) 802.11 data encapsulation format;

FIG. 23 is a signaling diagram of an example CAPWAP, split MAC intra-domain handover procedure;

FIG. 24 is a signaling diagram of an example CAPWAP, local MAC intra-domain handover procedure;

FIGS. 25A and 25B are a signaling diagram of an example SDN/OpenFlow Wireless intra-domain handover procedure; and

FIGS. 26A and 26B are a signaling diagram on an example CAPWAP+SDN/OpenFlow Wireless, split MAC, intra-domain handover procedure.

### DETAILED DESCRIPTION

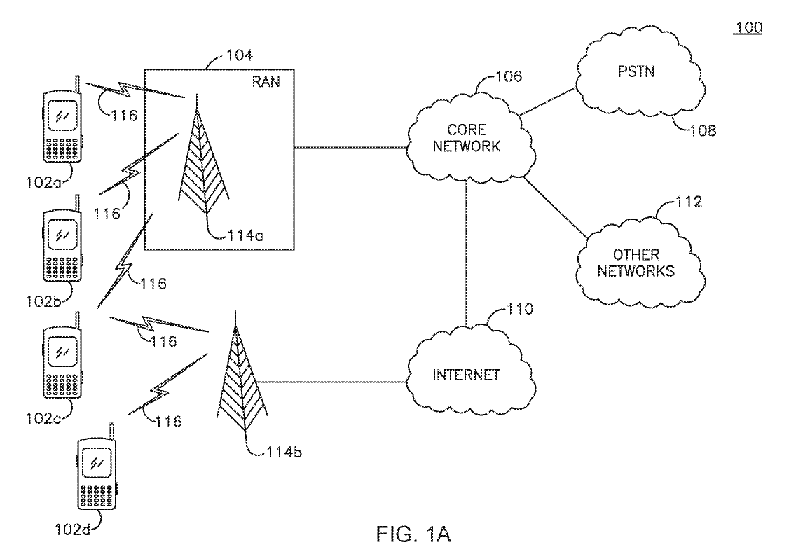

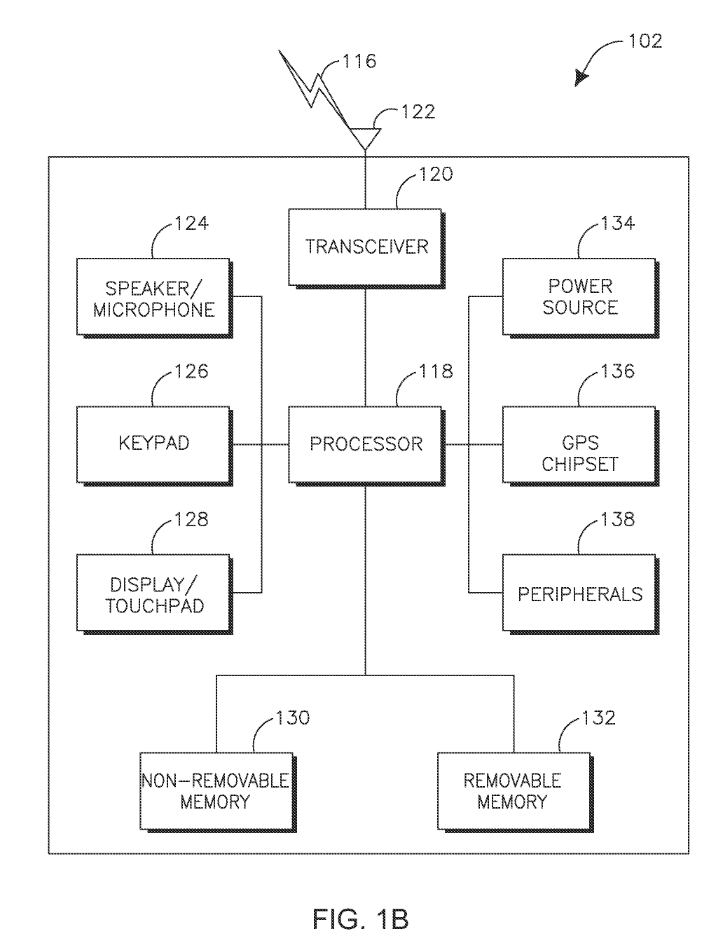

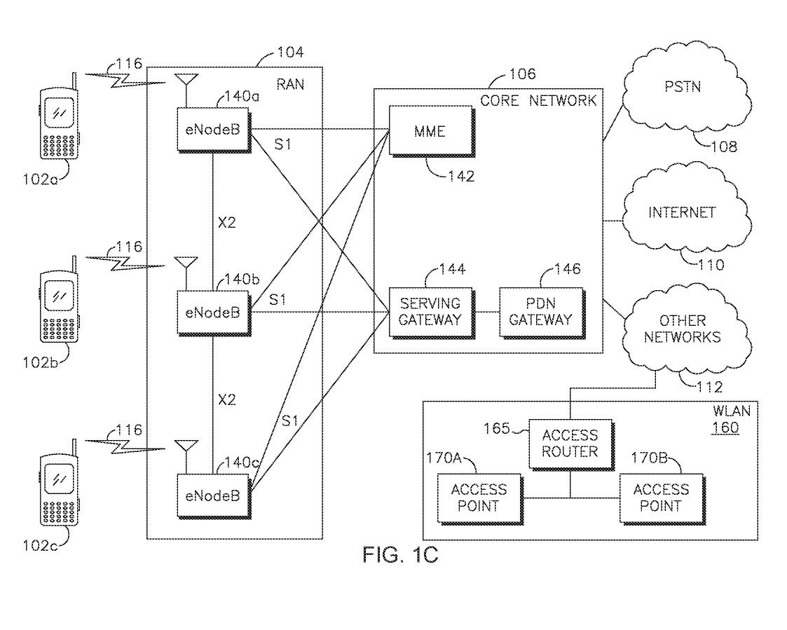

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the clisplay/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 of FIG. 1A, according to an exemplary embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management entity gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 140a, 140b, 140c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

Other network 112 may further be connected to an IEEE 802.11 based wireless local area network (WLAN) 160. The WLAN 160 may include an access router 165. The access router may contain gateway functionality. The access router 165 may be in communication with a plurality of access points (APs) 170a, 170b. The communication between access router 165 and APs 170a, 170b may be via wired Ethernet (e.g. IEEE 802.3 standards), or any type of wireless communication protocol. AP 170a is in wireless communication over an air interface with WTRU 102d.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices. An access router (AR) 150 of a wireless local area network (WLAN) 155 may be in communication with the Internet 110. The AR 150 may facilitate communications between APs 160a, 160b, and 160c. The APs 160a, 160b, and 160c may be in communication with STAs 170a, 170b, and 170c.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

Software Defined Networking (SDN) is a paradigm where the control and the data forwarding planes may be separated, allowing for a more flexible provision and configuration of network connections. With SDN, network administrators may program the control of the traffic in a centralized way, and may assist in the physical access to the network's hardware devices. In SDN, the control plane, which makes decisions about where traffic is sent from the underlying system, is decoupled from the data plane, which forwards traffic to the selected destination. This may increase the flexibility and extensibility of the network, for example deploying new protocols, policies and algorithms from centralized locations. In the description herein, access point (AP) and wireless terminal point (WTP) may be used interchangeably. Similarly, WTRU, mobile node (MN) and station (STA) may be used interchangeably.

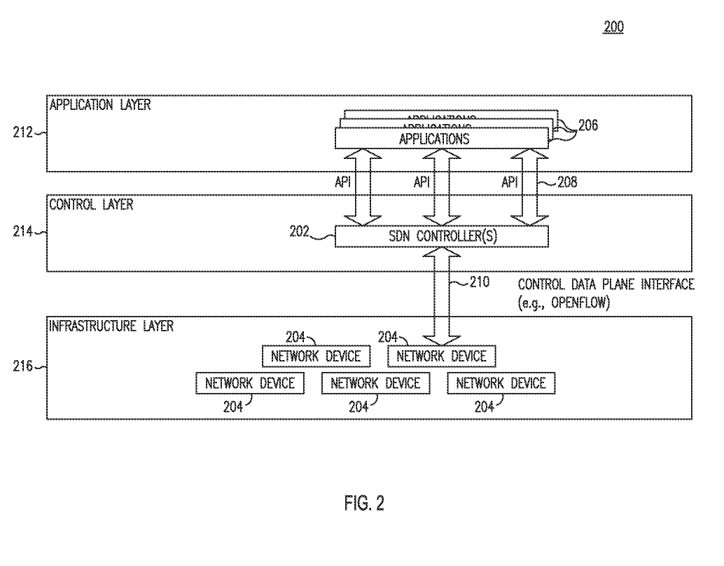

FIG. 2 is a logical diagram of an exemplary SDN architecture 200, in which the intelligence is centralized in software-based SDN controller(s) 202. The SDN controller(s) 202 may reside in a control layer 214 and interface with one or more network devices 204 located in the infrastructure layer 216, over a control data plane interface 210, for example OpenFlow. The SDN controller(s) 202 may also interface with one or more applications 206, located in an application layer 212, over one or more application programming interfaces (APIs) 208.

The SDN controller(s) 202 may be software-based, may have a global view of the network and may be capable of controlling, in a vendor-independent way, the network devices 204. In some instances, these network devices 204 may no longer need to implement and/or understand many different network protocol standards, but may provide the needed functionality by accepting instructions from the SDN controller(s) 202. This may in turn help administrators save time and resources, as the network behavior may be controlled and modified by programming it in the centralized SDN controller(s) 202, rather than writing complex and long configuration files in many different network devices 204 scattered across the network.

OpenFlow is a standardized interface between the control layer and forwarding layers of the SDN architecture that may be used with the embodiments described herein. OpenFlow may allow accessing and modifying the forwarding plane of network devices such as switches and routers. OpenFlow is just one example of a protocol for the interface between control and forwarding layers. It should be noted that other protocols for the interface between control and forwarding layers may be used with the embodiments described herein. In addition, some of the mechanisms described herein may use functionalities currently specified in the OpenFlow protocol, such as Internet Protocol version 6 (IPv6) support or Layer 3 (L3) tunneling.

Control And Provisioning of Wireless Access Points (CAPWAP) is a protocol that enables a centralized control in wireless networks. CAPWAP is technology agnostic and may use specific bindings for each considered access standard. Radio configuration may be expressed in terms of management information base elements included in the standard, such as the operating channel or the transmission power, but may also be expressed in terms of the beacon interval or the contention parameters used by the medium access scheme. With CAPWAP, control frames are delivered to a central controller, which is responsible for Medium Access Control (MAC) layer control, similar to the way OpenFlow delivers information about newly incoming flows to the controller.

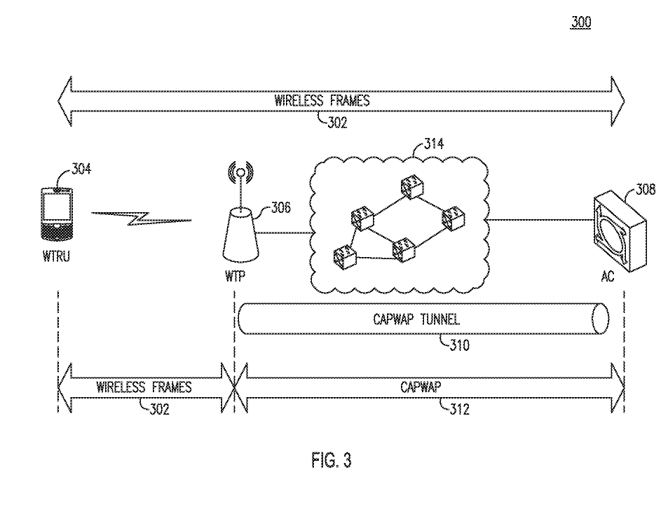

The CAPWAP protocol enables a central wireless local area network (LAN) Access Controller (AC) to manage a collection of Wireless Termination Points (WTPs). The protocol defines the AC and WTP control and data plane communication via a CAPWAP protocol transport mechanism. CAPWAP assumes a network configuration consisting of multiple WTPs communicating via an Internet Protocol (IP) network to an AC. WTPs may be viewed as remote radio frequency (RF) interfaces controlled by the AC. The CAPWAP protocol may support two modes of operation: Split MAC and Local MAC. In Split MAC mode, all Layer 2 (L2) wireless data and management frames may be encapsulated via the CAPWAP protocol and exchanged between the AC and the WTP. FIG. 3 is a system diagram of an example Control and Provisioning of Wireless Access Points (CAPWAP) Split Medium Access Control (MAC) architecture 300. As shown in the example of FIG. 3, the wireless frames 302 received from a mobile station (STA) 304 may be encapsulated by the WTP 306 and forwarded to the AC 308. The forwarding by the WTP 306 to the AC 308 may be done, for example, using the CAPWAP protocol 312 over CAPWAP tunnel 310. The CAPWAP tunnel 310 may be established through network 314, which may be an IP network such as the Internet, a private enterprise IP network, and/or a mobile core network, for example.

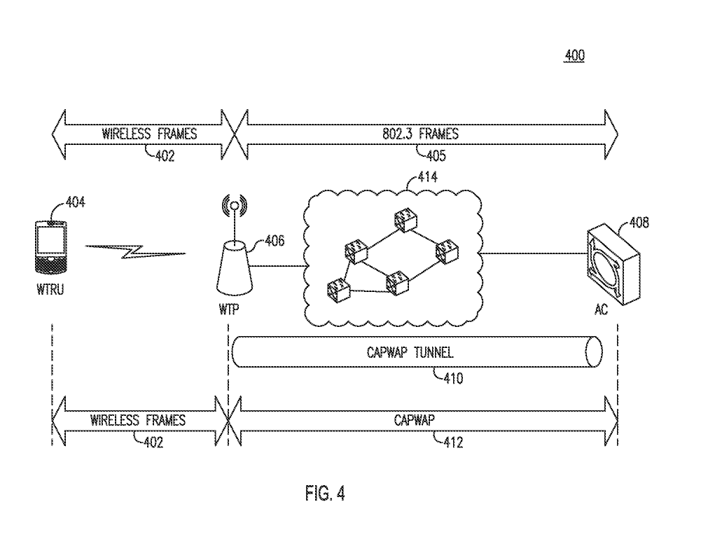

In the Local MAC mode of operation, the data frames may be locally bridged or tunneled as 802.3 frames. If the frames are tunneled, the WTP may perform the 802.11 integration function. In either case, the L2 wireless management frames are processed locally by the WTP and forwarded to the AC. FIG. 4 is a system diagram of an example CAPWAP Local MAC architecture 400. In the Local MAC mode in the example of FIG. 4, a WTRU 404 may transmit wireless frames 402 to the WTP 406, which may encapsulate the wireless frames 402 in 802.3 frames 405 to be tunneled to the AC 408 over CAPWAP tunnel 410 using CAPWAP protocol 412. The CAPWAP tunnel 410 may be established through network 414, for example. The CAPWAP protocol 412 transport layer may carry two types of payload: CAPWAP Data messages and CAPWAP Control messages. CAPWAP Data messages may encapsulate forwarded wireless frames 402. CAPWAP protocol Control messages may be management messages that may be exchanged between a WTP 406 and an AC 408.

WiFi systems, including IEEE 802.11 communication systems, that may be used as part of an integrated end-to-end Virtual Network solution are described herein. The extension of OpenFlow concepts to develop virtualization of wireless networks is also disclosed herein. OpenFlow has emerged as an industry-standards approach to providing an abstraction of Ethernet-based IP networks and a protocol for network management.

An exemplary use-case, which we refer to as “elastic cell”, may be useful in understanding how virtualization of wireless access may be of significant benefit. According to this exemplary use case, a mobile user, for example the pair <mobile device, user identity>, may be associated with a personalized cell by the mobile network operator. The mobile network operator may be virtual. A user-specific Service Set Identification (SSID) or Cell ID in a cellular network may be defined. Whenever a user is connected to, or is within a range of, a network that it can use for access, the user may see this personal SSID or cell ID. The user's device may attempt to connect to this network and get connected. Because the user may always see the same virtual network, mobility procedures are turned upside-down such that the user's device may not handover in the classical sense. Rather, access networks may continually reconfigure themselves to present so that the user can maintain uninterrupted connectivity to its personalized virtual network. While IPv6 is discussed herein for simplicity, other Internet Protocols, such as Internet Protocol version 4 (IPv4) may also be used in any embodiment described herein.

The teachings herein address the above “elastic cell” use-case. According to an exemplary embodiment, a network infrastructure to which a mobile node can attach may dynamically reconfiguring itself so that the mobile node does not realize that it is actually moving, even when the mobile node crosses different physical network and/or domains. This dynamic reconfiguration may not only cover classic mobility management, which ensures IP address continuity to the mobile node, as in Proxy Mobile IPv6, but may also cover dynamic and personalized wireless access and backhaul and core network reconfiguration, so that the network infrastructure may adapt to the specific mobile node needs.

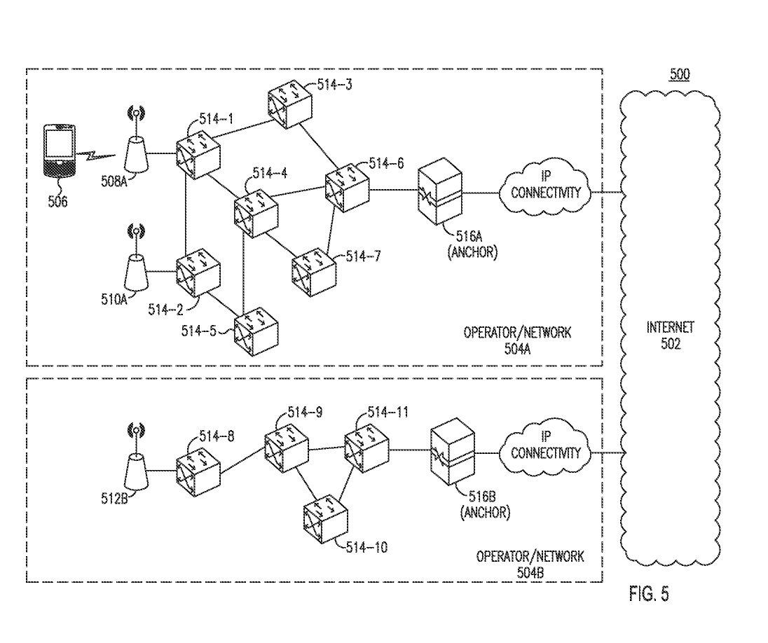

FIG. 5 is a system diagram of an example network architecture 500 where a mobile node is associated with a personalized cell. The example network architecture 500 includes two different networks/domains 504A and 504B, although any number of networks/domains may be included. Each network/domain 504A and 504B may be capable of providing network access to mobile nodes such as WTRU 506. Network/domain 504A may provide network access to a WTRU 506 via access points 508A, 510A, connected to anchor 516A over a series of switches (and/or routers) 514-1 to 514-7. Anchor 516A may act as a logical router to provide IP connectivity to the Internet 502 to the rest of the network/domain 504A. Similarly, network/domain 504B may provide network access to a WTRU via access point 512B, connected to anchor 516B over a series of switches (and/or routers) 514-8 to 514-11. Anchor 516B may act as a logical router to provide IP connectivity to the Internet 502 to the rest of the network/domain 504B.

WTRU 506 may be able to connect to the network/domain 504A via access point 508A (or access point 510A), which may provide a “virtual” L2 network specifically set-up for this particular WTRU 506. This L2 network may effectively follow the WTRU 506 while roaming within the same network/domain 504A. The network/domain 504A may even follow the WTRU 506 between domains, for example to network/domain 504B, if the appropriate roaming agreements are in place.

The above-described virtual network concept may not be limited to the L2 network where the mobile node is attached, but may also include the L3 network that is visible to it. For example, the mobile node may keep the same IP address that is initially allocated when first attaching to the network. In this case, the mobile node it is provided with IP address continuity, and may keep using the same default IPv6 router. From the point of view of the mobile node, it appears that there is no mobility involved despite the different handovers it might perform.

Virtual networks may be created on-demand as mobile nodes appear, or may be pre-configured. The characteristics of a virtual network may be tailored to the specific needs of the mobile node it serves. For example, these characteristics may include, but are not limited to, frequency band, security scheme, and/or wireless multimedia extensions. The network may also take into consideration its environment and the network load/status, for example to adjust the transmission power, the operating channel, and/or Request to Send/Clear to Send (RTS/CTS).

Besides network access characteristics, service/network parameters may also be tuned per user. For example, a virtual network may be only IPv4, as some clients/applications may have issues when operating on a dual-stack network. In another example, a virtual network may be only IPv6 or may be dual stack. In another example, one virtual network may provide access to certain local content (e.g., videos), whereas others may not. In another example, one virtual network may provide connectivity to a local corporate network, for example a virtual private network (VPN)-type of service.

When the need to connect to a new network arises due to low signal quality from the current point of attachment when an already connected mobile node moves, the network may configure neighboring radio accesses to provide candidate targets to the mobile node that belongs to the same L2 network. This virtual L2 network may also be connected to the same logical L3 network. This may effectively create a virtual network that “follows” the mobile node.

In this scenario, the network may also force or suggest the mobile node to move to a different point of attachment belonging to the same virtual L2 network. This may provide several benefits. For example, the mobile node's connection manager may not need additional intelligence to decide where to attach to when it has to change L2 network due to signal quality reasons. Additionally, since the mobile node “sees” the same network, the handover procedures are simplified, because a new L2 attachment may not be needed but rather a re-association, and thus an L3 handover may not be involved.

An example of a potential deployment realization of the virtual network concept may include, but is not limited to, network access that may be provided in transportation platforms, such as airports and train stations. Users may access the Internet, and/or corporate networks, while waiting for their selected mode of transportation, such as flights or trains. A virtual network instance may be created per user, or per type of user, based on different criteria, including for example the airline operating the flight. This virtual network may follow the user while moving within the airport, for example, inside the terminal, while waiting at a coffee shop at the station or airport, or when commuting between terminals, and even when getting into the plane or train, if the plane or train also provides in-flight WiFi access.

Another example of a potential deployment of the virtual network concept may include network access provided in campus scenarios, which may include, but are not limited to universities, company buildings, hospitals, and city halls Users may be provided with a tailored network access, according to their profiles. This customized virtual network may follow the user while moving within the premises. Another example of a potential deployment realization of the virtual network concept may include municipal network access provided within urban areas of cities. This scenario may allow different kinds of virtual networks to be provided to users, for example to provide differentiated services to premium users.

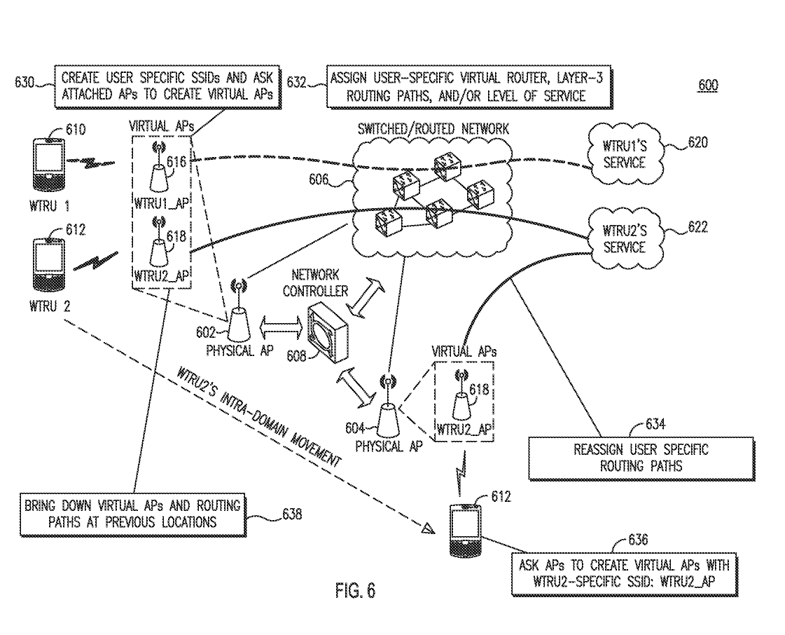

According to an embodiment, a virtualized WiFi network (e.g. IEEE 802.11 network) may create user-specific virtual networks that may follow the mobile nodes as they move around within the same network domain. FIG. 6 is a system diagram of an example virtual network management system 600 and procedures 630-638 to enable a virtualized WiFi network. The example of FIG. 6 shows a simplified WiFi network including two physical APs 602 and 604 interconnected by a switched and/or routed network 606. Network devices, including the APs 602 and 604, and switches and routers in switched/routed network 606, may be managed by one or more centralized network controllers, such as network controller 608. Although not shown, the concepts described herein can be extended to any number of network devices including one or more network controllers, APs, switches, routers and WTRUs (mobile nodes). Network controller 608 may be an extended version of a CAPWAP controller, an extended version of an SDN/OpenFlow controller, or a bundle of the two.

Network controller 608 may include a network controller extension and may interact with the APs 602 and 604 to create, orchestrate and/or destroy user-specific virtual networks, as described below. Solutions for various controller choices, such as a CAPWAP controller, a SDN/OpenFlow controller or a bundle of these two, are also described herein. The network controller 608 may process two essential network events of a virtualized WiFi network: initial network attachment and inter-domain handover. FIG. 6 shows the key procedures 630-638 of how the network controller 608 may manage the virtual networks 616 and 618 when these two events take place.

The initial network attachment procedure may include procedures 630 and 632. When WTRUs 610 and 612 (e.g. WTRU1 and WTRU2) try to attach to network 606 initially, the network controller 608 may create virtual networks 616 and 618 for each WTRU 610 and 612, respectively. Each WTRU 610 and 612 may use the network 606 to gain access to its services 620 and 622, respectively. The controller 608 may identify the WTRUs 610 and 612, and, according to example procedure 630, assign user-specific SSIDs or other virtual AP identifiers for each WTRU 610 and 612. The controller 608, according to example procedure 630, may also ask the physical APs 602 and/or 604 to create virtual APs 616 and 618 with the assigned SSIDs WTRU1_AP and WTRU2_AP, respectively.

As part of procedure 630, the controller 608 may create SSID “WTRU1_AP” for WTRU 610 and SSID “WTRU2_AP” for WTRU 612. The controller 608 may also ask the APs 602 and 604, which the WTRUs 610 and 612 want to attach to, to create virtual APs 616 and 618 using these two SSIDs WTRU1_AP and WTRU2_AP. On the networking side as part of procedure 632, the controller 608 may configure the switches and routers in network 606 so that each WTRU 610 and 612 can have a user-specific virtual router, a designated layer-3 routing path, and/or desired level of services 620 and 622, for example.

According to an example inter-domain handover procedure, when WTRUs, for example WTRU 612, moves around within the network domain, the network controller 608 may anticipate the movement of WTRU 612 and may create virtual networks 618 along the way with the SSID WTRU2_AP associated with WTRU 612. In the example shown in FIG. 6, WTRU 612 moves from one location to another. The controller 608 may ask the physical APs 602 and 604 at WTRU's 612 movement destination and along the path to create virtual APs 618 with SSID “WTRU2_AP”. As a result, as WTRU 612 moves, a virtual AP 618 that can be recognized by WTRU 612 follows WTRU 612 along the way. In other words, inter-domain handover procedures may be processed on the network side and WTRU 612 may not go through such handover procedures on its side.

On the networking side according to example procedure 634, the controller 608 may continuously reassign user-specific routing paths as WTRU 612 moves from one AP to another. As a result, WTRU 612 may keep its IP address and level of service, and see no service interruption during the movement. In addition to creating new virtual network 618 (with SSID WTRU2_AP) at the WTRU's 612 new locations at physical AP 604 as part of procedure 636, the controller 608 may also delete old virtual networks 618 at the WTRU's 612 previous location at physical AP 602 as part of procedure 638. When the WTRU 612 detaches from a physical AP 602, the controller 608 may bring down the virtual APs 618 at the detached AP 602 and may delete the routing path to or from this location. In the example shown in FIG. 6, the controller 602 brings down virtual APs 618 with SSID “WTRU2_AP” at the original physical AP 602 and deletes routing paths which route traffic to WTRU2's 612 previous locations.

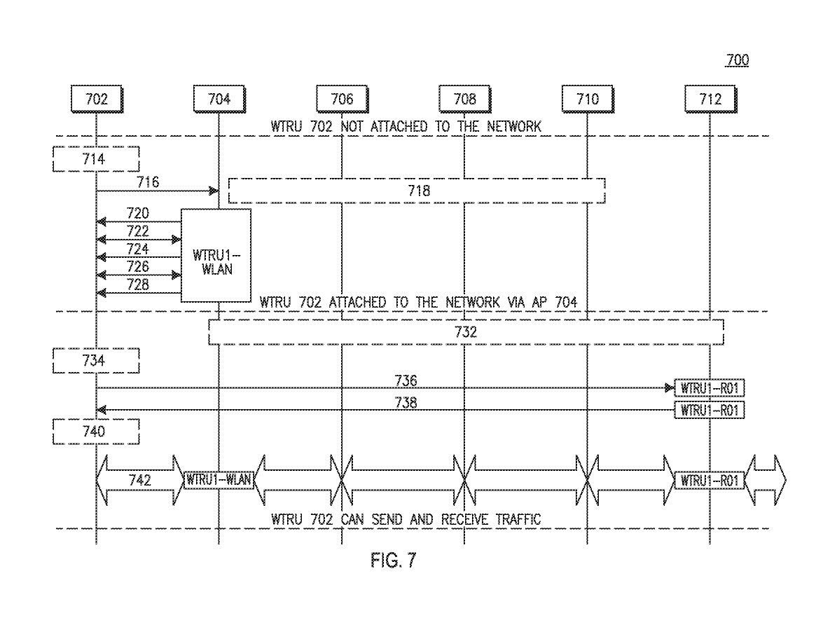

The initial network attachment and intra-domain handover procedures of the a virtual network, such as a virtualized WiFi network, are disclosed herein. FIG. 7 is a signaling diagram of an example initial network attachment procedure 700. In the example of FIG. 7, the network may include WTRU 702, AP 704 (e.g. IEEE 802.11 AP), switches 706, 708, 710, and router 712. It is assumed that the WTRU 702 starts out not attached to the network.

At 714, the WTRU 702 may scan for available networks, which may involve actively probing and/or searching for networks in its area including 802.11 networks. The Probe Request frames, 716, may be sent by WTRU 702 and received by AP 704, which may be an IEEE 802.11 access point for example. At 718, the network, based on L2 information, or by other means, may identify WTRU 702 and may allocate a virtual L2 and/or L3 network exclusively for the use of WTRU 702. In this example, the selected virtual L2 network may be identified by the network name and/or Extended SSID (ESSID) “WTRU1-WLAN”. The virtual network's security, authentication and encryption type may also be set-up specifically for WTRU 702 based on its profile and capabilities.

Using the selected parameters, AP 704 may reply to the Probe Request frame 716 sent by WTRU 702 with a Probe Response, 720. WTRU 702 and AP 704 may also exchange authentication request message, 722, and authentication response message, 724, and association request message, 726, and association response message, 728, which then completes the L2 attachment signaling. This may be implemented by configuring a virtual access point with ESSID WTRU1-WLAN on AP 704.

At this point, WTRU 702 is attached to the network via AP 704. In addition to the logical L2 network allocated to WTRU 702, a logical L3 network may also be configured for WTRU 702, at 732. The configuration of the logical L3 network, 732, may include: selecting an IPv6 prefix (e.g. PrefWTRU1::/64); selecting an L3 anchor or physical anchoring point to provide IP connectivity, identified as router 712 in this example; creating a logical instance of an L3 router or a virtual router logical entity (e.g. L2 and L3 link local addresses) identified as “WTRU1-R01” in this example; and/or once this logical router identity is configured on router 712, the network may ensure that there is a forwarding path between AP 704 and router 712, or more specifically, between the virtual AP WTRU1-WLAN (residing on AP 704) and the logical router instance WTRU1-R01 (residing on router 712). This could be done, for example, using OpenFlow in case the network is SDN-capable.

The logical router WTRU1-R01 may represent a virtual next IP hop and/or L3 attachment point that may be in charge of handling L3 traffic from the WTRU 702. This may be implemented as a logical interface running on a router and/or switch that is capable of forwarding and/or receiving traffic using the IP address associated with or anchored by this logical router WTRU1-R01. Other approaches to implementing a logical router instance may be used, for example, by running a virtual machine on the physical box hosting it.

WTRU 702 may send Router Solicitation messages 736 to discover the default router and request IP connectivity. One of the messages will be forwarded to WTRU 702's L3 attachment point WTRU1-R01 located at router 712. The attachment point WTRU1-R01 located at router 712 may respond with a Router Advertisement, message 738, to configure network addresses, and/or advertise itself as the default router for WTRU 702.

At 740, upon receiving the Router Advertisement message 738, WTRU 702 may configure an IPv6 address (e.g. PrefWTRU1::WTRU1/64) from the allocated prefix and configure its default route via virtual router WTRU1-R01 (at router 712). For example, stateless auto-configuration or stateful mechanisms, such as Dynamic Host Configuration Protocol version 6 (DHCPv6), may also be used. At 742, data traffic to and from WTRU 702 may be exchanged between WTRU 702 and the Internet using the allocated IPv6 address (e.g. PrefWTRU1::WTRU1/64).

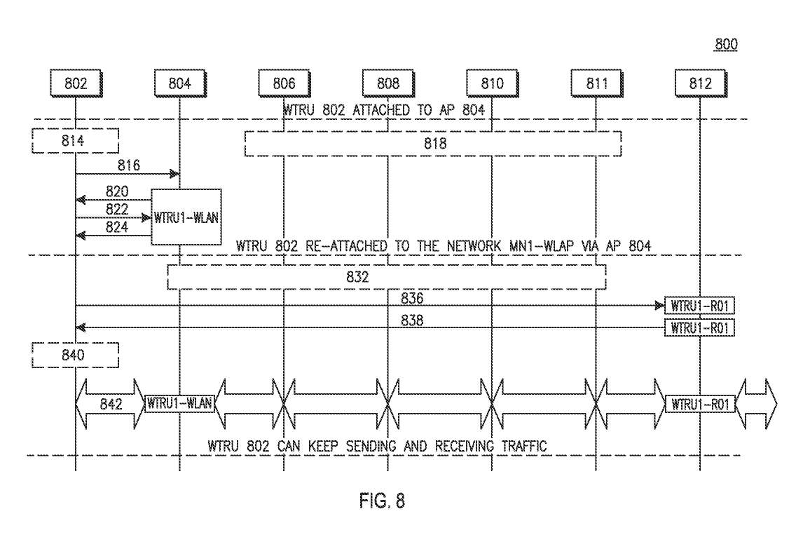

FIG. 8 is a signaling diagram of an example intra-domain handover procedure 800. In the example of FIG. 8, the network may include WTRU 802, AP 804 (e.g. IEEE 802.11 AP), switches 806, 808, 810, 811 and router 812. It is assumed that the WTRU 802 starts attached to the network via AP 804. In this example, it is also assumed that WTRU 802 is moving out of the coverage of its current L2 point of attachment, AP 804, and may experience low signal quality from AP 804. This may trigger WTRU 802 to scan search for alternative access points belonging to the same Extended Service Set (ESS), 814. The trigger may come from other sources, for example, the network.

When WTRU 802 sends Probe Request frames, 816, searching for WTRU1-WLAN access points, these Probe Request frames 816 may be received by AP 804, which, at 818, may identify WTRU 802, recreate the same logical wireless network and allow WTRU 802 to re-associate to it, and create a virtual AP instance of WTRU1-WLAN on AP 804. The AP may respond with a Probe Response message 820. AP 804 may learn the needed information in various ways. For example, the information may be based on the ESSID included on the Probe Requests 816 sent by WTRU 802 and the use of a centralized database, for example. Through the exchange of a re-association request 822 and a re-association response message 824, WTRU 802 may re-attach to the network via virtual AP WTRU1-WLAN located on AP 804.

Since WTRU 802 has changed its location in the network, at 832, the network may update the forwarding path to ensure that there is connectivity between the virtual AP WTRU1-WLAN running on AP 804 and the logical router instance WTRU1-R01 running on router 812. This could be done for example using OpenFlow if the network is SDN-cap able, using IP tunneling by Proxy Mobile IPv6, or even using routing updates, for example internal-Border Gateway Protocol (iBGP). At 840, WTRU 802 may keep its L3 configuration such that there may be no change to its L3 point of access (PoA) from its point of view. WTRU 802 may send out Router Solicitation messages 836 to re-discover the default router and/or validate its IP connectivity. One of the messages may be forwarded to the WTRU 802's L3 attachment point WTRU1-R01 located on router 812. The attachment point WTRU1-R01 on router 812 may respond with a Router Advertisement, 838, to reconfigure network addresses, and/or advertise itself as the default router for WTRU 802. Once complete, WTRU 802 may be able to send and receive data traffic, 842, using the same IP address as it was using before the handover.

Implementation of the procedures discussed above may employ protocols including, but not limited to: the CAPWAP protocol without using any SDN/OpenFlow mechanisms; an SDN/OpenFlow capable network with wireless extensions to provide the virtual network functionality; CAPWAP+SDN/OpenFlow Wireless, a combination of the previous two approaches. The approach of the CAPWAP protocol without using any SDN/OpenFlow mechanism may have the advantage of introducing minor extensions to a standard that is the base for many deployed WLAN products, some of them via proprietary variations. The approach of an SDN/OpenFlow capable network with wireless extensions may be potentially well aligned with the work that will be done within the Open Networking Foundation Wireless & Mobile Working Group. The approach of CAPWAP+SDN/OpenFlow Wireless may combine the advantages of the former two approaches.

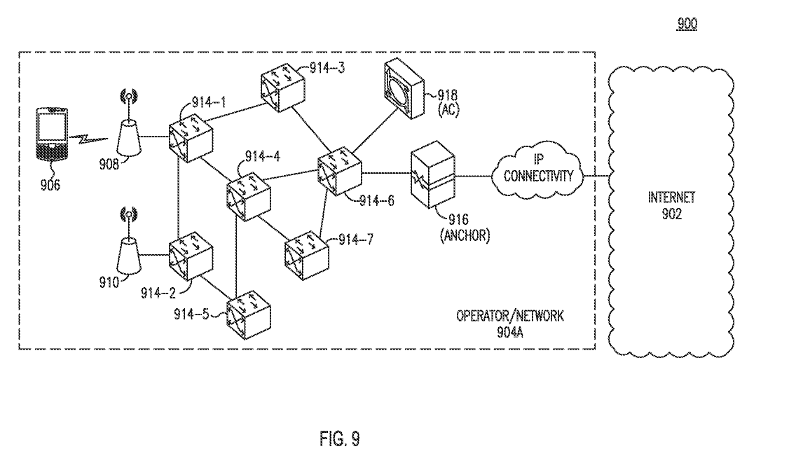

FIG. 9 is a system diagram of an example CAPWAP network architecture 900. In this example, WN 906 may connect to the Internet 902 over the network 904A. The network 904A may include one or more L2 points of attachment, called Wireless Termination Points (WTPs) 908 and 910, connected over a series of switches/routers 914-1 to 914-7 to a wireless LAN controller or Access Controller (AC) 918, which may be collocated with anchor 916 if it also has L3-routing functions.

CAPWAP, as well as other proprietary approaches of WiFi deployments, may supports different model, for example, the “thin AP/split MAC”, the “fat AP/local MAC” and the “hybrid”. The differences between these models may concern which function are executed on the WTP(s) 908, 910 and which functions are executed on the AC 918. While a “fat AP” may be similar to a regular AP in terms of user data plane, the “thin AP” may allow moving significant parts of the MAC operations to the AC 918. For the purposes of the “virtual network”, the CAPWAP thin AP/split MAC model may be a better selection, as it allows the AC 918 to receive the scanning management frames sent by unassociated stations (STAs) (i.e. mobile nodes (WTRU)). Whereas, in the fat AP/local MAC, only association frames may be forwarded to the CAPWAP AC 918.

According to another approach, a SDN/OpenFlow Wireless based architecture may be used. In this approach, which is conceptually similar to the CAPWAP approach in FIG. 9, the deployed network may be OpenFlow capable, and may have extensions allowing the programmability of certain wireless aspects. This may be related to OpenFlow configuration (OF-Config).

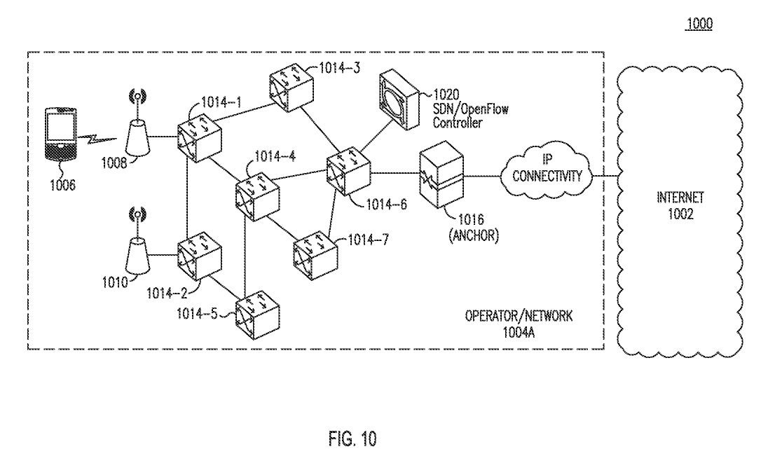

FIG. 10 is a system diagram of an example SDN/Open Flow Wireless Network architecture 1000. In this example, WN 1006 may connect to the Internet 1002 over the network 1004A. The network 1004A may include one or more L2 points of attachment, called WTPs 1008 and 1010, connected over a series of switches/routers 1014-1 to 1014-7 to a SDN/OpenFlow Controller 1020, which may be collocated with anchor 1016 if it also has L3-routing functions. The differences from other SDN/OpenFlow networks may include the following: Aps 1008, 1010 may be SDN/OpenFlow capable, meaning that their IEEE 802.11 ports may also be configured using SDN/OpenFlow (for example, matching rules against L2 management/control frames or using the 4/6-address format of IEEE 802.11 frames); and extensions to OpenFlow and/or OF-Config may be defined to allow programmability of IEEE 802.11 aspects. This may involve, for example, the capability to program matching rules for 802.11 management frames and configuration of virtual APs (not shown) over a physical interface.

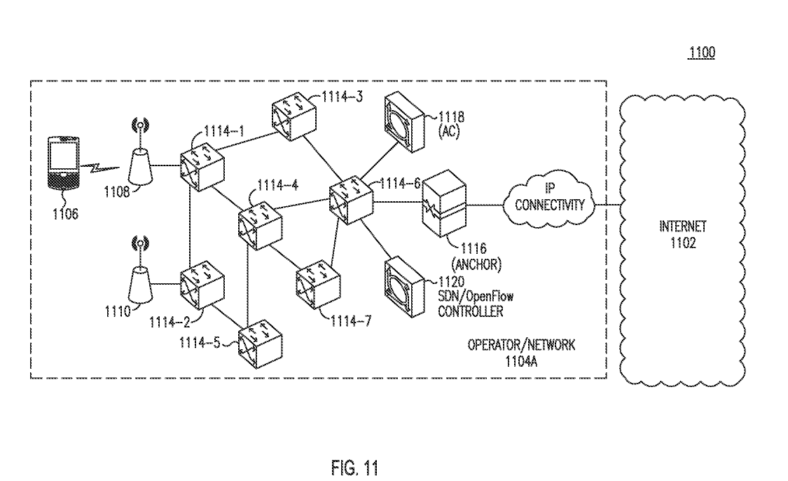

According to another approach, a CAPWAP+SDN/OpenFlow Wireless based architecture may be used. FIG. 11 is a system diagram of an example CAPWAP+SDN/OpenFlow Wireless architecture 1100. The network 1104A may include one or more WTPs 1108 and 1110, connected over a series of switches/routers 1114-1 to 1114-7 to an SDN/OpenFlow Controller 1120 and an AC 1118, either of which may be collocated with anchor 1116 if it also has L3-routing functions.

According to a CAPWAP+SDN/OpenFlow Wireless approach, the network infrastructure between the CAPWAP WTPs 1108, 1110 and the AC 1118 may be SDN/OpenFlow capable, so that the data forwarding between WTPs 1108, 1110 and AC 1118 for both CAPWAP control and tunneled data packets may be dynamically configured, for example using OpenFlow.

In this scenario, the forwarding path in the SDN/OpenFlow switches 1114-1 to 1114-7 may be pre-configured for CAPWAP signaling and dynamic configuration may be used for the tunneled data packets, allowing for fine-grained traffic engineering. Depending on the deployment scenario, the SDN/OpenFlow controller 1120 may be co-located with the AC 1118. Similarly, in the “split MAC” model, which has data traffic tunneled between the WTP 1108, 1110 and the AC 1118, it may be beneficial to co-locate the L3 anchoring functionality (i.e. anchor 1116) with the CAPWAP AC 1118.

L2 Network discovery and initial attachment procedure is disclosed herein. A first step may be the discovery of available access points by the mobile node. This may also involve discovery of associated capabilities of the networks accessible via the existing access points, so that the WTRU may decide which AP attach to. This may be related to the IEEE 802.11u protocol, now part of IEEE 802.11-2012, Generic Advertisement Service/Access Network Query Protocol (GAS/ANAP) extensions and also with the 802.11aq TG, which allows for obtaining information about network services and capabilities before association to any AP.

One function of the virtual network use case may be to create a particular and isolated network, both from L2 and L3 points of view, for each authorized WTRU. This virtual network may then follow the WTRU while moving within a domain, where this service is provided.

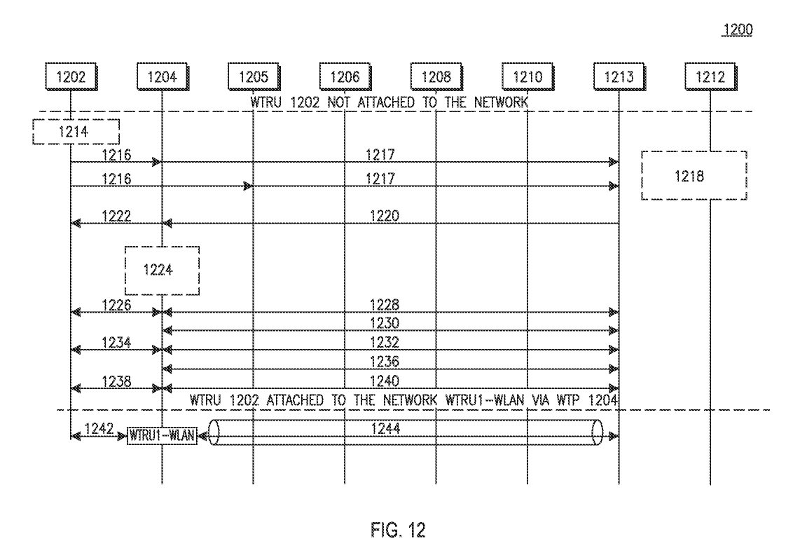

For the procedures described in the signaling diagrams FIGS. 12-27B, any of the elements may be included or omitted in any procedure. Moreover, elements of a procedure may be included in other procedures, although not specifically indicated and details described with respect to an element in a procedure may be applicable to a corresponding similar element in any other procedure.

FIG. 12 is a signaling diagram of an example CAPWAP-based, split MAC L2 network detection and initial attachment procedure 1200, in accordance with an embodiment. The example network includes WTRU 1202, WTPs 1204, 1205, switches 1206-1210, CAPWAP AC 1213 and anchor 1212. FIG. 12 shows how a CAPWAP based architecture can support the network detection and initial attachment, at L2, as used in the “virtual network”. Note that initial CAPWAP discovery and configuration procedures between the WTPs 1204, 1205 (e.g. 802.11 Aps) and the AC 1213 are not shown. It may be assumed that at the start WTRU 1202 is not attached to the network.

At 1214, a mobile node WTRU 1202 (e.g. 802.11 STA) may arrive at the network and perform a network detection procedure, which may include actively probing the network. It may be assumed that WTRU 1202 is in radio coverage of two WTPs 1204 and 1205, which may not be sending beacon frames. In an alternative CAPWAP approach, virtual or logical WLANs may be pre-configured using the IEEE 802.11 Add WLAN primitive, and WTPs (i.e. Aps 1204, 1205) may send periodic beacons for these networks.

Referring to FIG. 12, WTRU 1202 may send several Probe Request frames 1216, also referred to as active probing, which may be received by both WTPs 1204 and 1205. At 1217, the Probe Requests are forwarded to the AC 1213 by the WTPs 1204, 1205. In a CAPWAP alternative not shown in FIG. 12, the Probe Requests 1216 may be processed by the WTPs 1204, 1205, which may generate Probe Responses 1222 without waiting for any further command from the AC 1213; the Probe Requests may be forwarded to the AC 1213 for processing.

Referring to FIG. 12, the AC 1213 may wait a pre-configured amount of time to be able to process all potential Probe Request frames 1216 from the same WTRU, allowing time to receive from other WTPs 1204, 1205. At 1218, The AC 1213 may perform any of the following: identify the WTRU 1202 based on its MAC address, or different out-of-band mechanisms may be used to identify it though the WTRU 1202 has not yet authenticated to the network; decide, based on different criteria (e.g., the load and/or location of the WTPs 1204, 1205) which WTP 1204 or 1205 is going to serve the WTRU 1202; and/or the AC 1213 may create a virtual WLAN with SSID=WTRU1-WLAN or a wild card SSID, for example.

At 1220, the AC 1213 may send an IEEE 802.11 “Add” WLAN primitive to WTP 1204 indicating SSID=WTRU1-WLAN. This Add WLAN primitive message 1220 may include the authentication and security scheme to be used, which may indicate support of 802.1X and Advanced Encryption Standard-Counter-Mode Cipher Block Chaining (CBC) Message Authentication Code (MAC) Protocol (CCMP) (AES-CCMP), for example. WTP 1204 may send a Probe Response frame 1222 to WTRU 1202 also identifying the SSID=WTRU1-WLAN. At 1224, a virtual WLAN with SSID=WTRU1-WLAN may be created at WTP 1204. In a CAPWAP alternative, this would also cause the WTP 1204 to send periodic broadcast beacons, which may be limited to unicast beacons.

Referring to FIG. 12, at 1226 and 1228, The WTP 1204 may forward the IEEE 802.11 Authentication and/or Association frames to the WTRU 1202 and/or the AC 1213, such that AC 1213 may be responsible for replying to the WTRU 1202 (e.g. client). Once the authentication and/or association process (1226 and 1228) is complete, the AC 1213 may transmit a Station Configuration Request message 1230, which may include an Add Station message element (e.g. Add Station (WTRU1 MAC), and/or IEEE 802.11 Add Station (WTRU1-WLAN)), to the WTP 1204. In an example, the WLAN may have been configured for IEEE 802.1X, and therefore the IEEE 802.11 Station Session Key may also be included in the Station Configuration Request message 1230 with the flag field's “A” bit set (e.g., IEEE 802.11 Session Key (Flag=C)).

If the AC 1213 is providing encryption/decryption services, as assumed in the example of FIG. 12, the WTRU 1202 (e.g. the client) may perform an IEEE 802.11 key exchange, at 1232 and 1234, with WTP 1204 and AC 1213, respectively. The AC 1213 may transmit another Station Configuration Request message 1236, which may include any of the following: an Add Station message element (WTRU1 MAC), an IEEE 802.11 Add Station message element (WTRU1-WLAN), which may include the WLAN Identifier with which the station has associated, and an IEEE 802.11 Station Session Key message element with the flag field's “C” bit enabled, indicating that the AC 1213 will provide crypto services.

The WTP 1204 may receive IEEE 802.11 Management Action frames 1238 from the WTRU 1202 and may forward the IEEE 802.11 Management Action frames 1240 to the AC 1213. As a result of the above, the WTRU 1202 is attached to the virtual WTRU1-WLAN network via WTP 1204. As such, IEEE 802.11 station data frames 1242 and 1244 may be tunneled between the WTRU 1202, the WTP 1204 and the AC 1213.

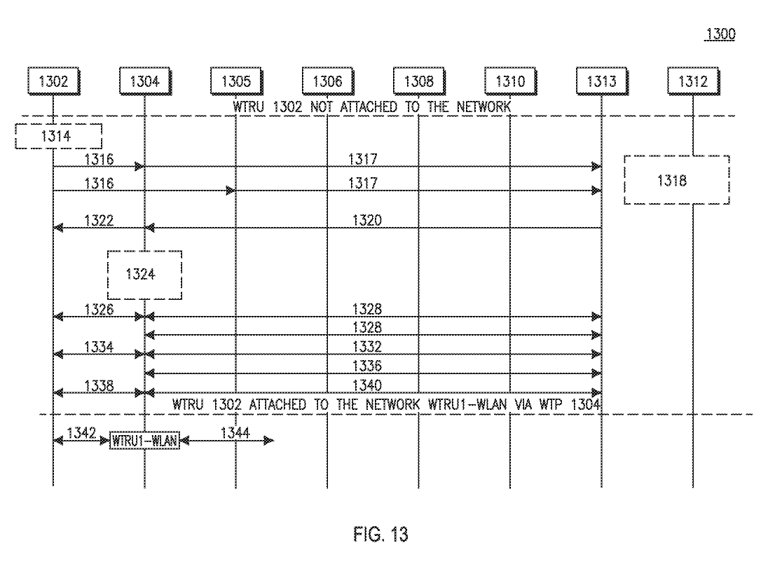

FIG. 13 is a signaling diagram of an example CAPWAP-based, local MAC L2 network detection and initial attachment procedure 1300. The example network includes WTRU 1302, WTPs 1304, 1305, switches 1306-1310, CAPWAP AC 1313 and anchor 1312. It may be assumed that at the start WTRU 1302 is not attached to the network. In this example, the elements 1314 through 1334 in FIG. 13 behave the same as corresponding elements 1214 through 1234, as described above with respect to FIG. 12, and thus are not repeated here.

With reference to FIG. 13, the AC 1313 may transmit another Station Configuration Request message 1336, which may include: an Add Station message element that may include a Virtual LAN (VLAN) name (e.g. WTRU1 MAC), which when present may be used by the WTP 1302 to identify the VLAN on which the user's data frames 1342 are to be bridged; an IEEE 802.11 Add Station message element, which may include the WLAN Identifier with which the WTRU 1302 has associated (e.g. WTRU1-WLAN); an IEEE 802.11 Station Session Key message element, which may include the pair wise encryption key (e.g. key=x); and/or an IEEE 802.11 Information Element message element, which may include the robust security network information element (RSNIE) to the WTP 1304, stating the security policy to enforce for the client (e.g. AES-CCMP).

The WTP 1304 may receive IEEE 802.11 Management Action frames 1338 from the WTRU 1302 and may forward the IEEE 802.11 Management Action frames 1340 to the AC 1313. As a result of the above, the WTRU 1302 is attached to the virtual WTRU1-WLAN network via WTP 1304. The WTP 1304 may locally bridge client data frames 1342 and provide the needed encryption and decryption services. The WTP 1304 may also tunnel client data frames 1344 to the AC 1313, using 802.3 frame tunnel mode or 802.11 frame tunnel mode, for example.

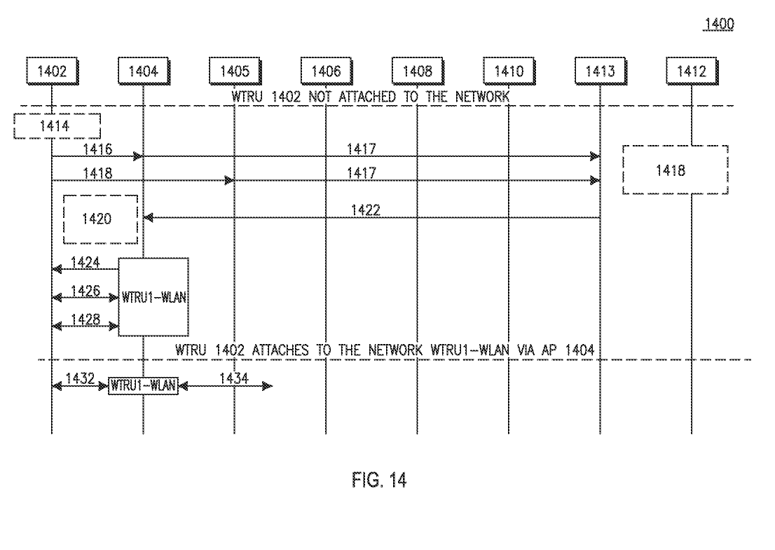

FIG. 14 is a signaling diagram of an example SDN/OpenFlow Wireless L2 network detection and initial attachment procedure 1400. The example network includes WTRU 1402, APs 1404, 1405 (e.g. 802.11 APs L2PoA01 and L2PoA02), switches 1406-1410, SDN/OpenFlow controller 1413 and anchor 1412. The applications and/or intelligence of the SDN/OpenFlow controller 1413 may be executed outside the controller 1413, for example via a Northbound interface/protocol.

Referring to FIG. 14, WTRU 1402 may send several Probe Request frames 1416, also referred to as active probing, which may be received by both AP 1404 and AP 1405. The SDN/OpenFlow Wireless capable APs 1404, 1405 may forward the Probe Requests 1417 to the SDN/OpenFlow controller 1413. OpenFlow may be extended so that management frames such as Probe Requests can be matched and forwarded with OpenFlow. SDN/OpenFlow rules may be pre-programmed or may rely on the absence of matching rules and a default policy of forwarding these frames to the controller 1413.

The SDN/OpenFlow controller 1413 may wait a pre-configured amount of time to be able to process all potential Probe Request frames 1417 received from the same WTRU 1402. At 1418, the SDN/OpenFlow controller 1413 may perform any of the following: identify the WTRU 1402 based on its MAC address and/or different out-of-band mechanisms; decide, based on different criteria (e.g., the load and/or location of the WTPs 1404, 1405) which AP 1404, 1405 is going to serve the WTRU 1402; and create a virtual WLAN, with SSID=WTRU1-WLAN, for example.

The SDN/OpenFlow controller 1413 may send an SDN/OpenFlow message 1422 to the selected AP, which is AP 1404 in this example. For example, the SDN/OpenFlow message 1422 may be sent with an OF-Config message (e.g. OF-Config[set-config(new VLAN, SSID=WTRU1-VLAN, additional info)]). SDN/OpenFlow message 1422 may contain information to configure a virtual AP on physical AP 1404, including, but not limited to, an SSID (e.g. SSID=WTRU1-VLAN), basic service set identification (BSSID), channel, authentication parameters, and/or security parameters, for example.

At 1420, the virtual WLAN SSID=WTRU1-WLAN may be configured on AP 1404, at which point AP 1404 may send a Probe Response frame 1424. The AP 1404 and WTRU 1402 may also complete authentication and association procedures 1426, as well as 802.1X authentication and/or 802.11 key exchange 1428, for WTRU 1402. At this point, WTRU1 is attached to the virtual WLAN (SSID=WTRU1-WLAN) at L2. At 1430, the SDN/OpenFlow controller 1413 may configure the user plane forwarding rules to allow L3 configuration to the AP 1404 with the selected anchor 1412 (described in further detail below). The AP 1404 may locally bridge client data frames 1432 and provide the needed encryption and decryption services. The AP 1404 may also tunnel client data frames 1434 to the SDN/OpenFlow controller 1413.

Methods for supporting the network detection and initial attachment, at L2, using a CAPWAP+SDN/OpenFlow Wireless based architecture for the virtual network are disclosed herein. Although initial CAPWAP discovery and configuration may be assumed, the description of the initial CAPWAP discovery and configuration procedures between the WTPs and the AC are omitted.

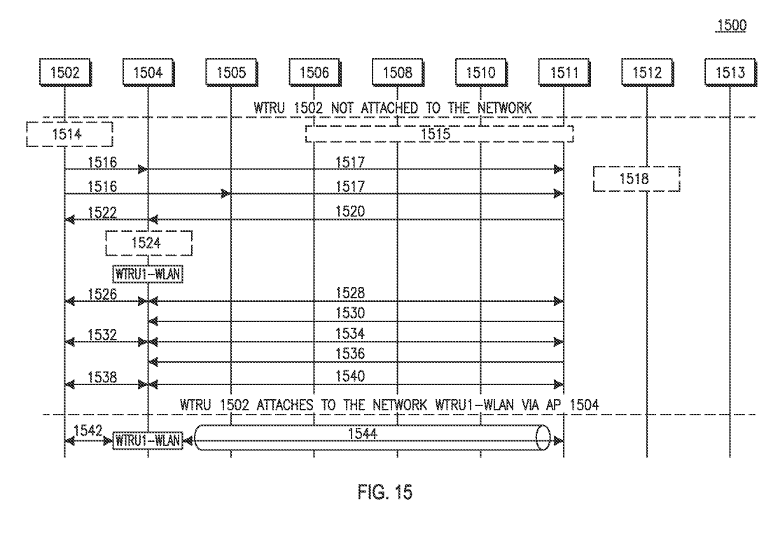

FIG. 15 is a signaling diagram of an example CAPWAP+SDN/OpenFlow Wireless, split MAC, L2 network detection and initial attachment procedure. The example network includes WTRU 1502, APs 1504, 1505 (e.g. 802.11 APs and/or CAPWAP WTPs, L2PoA01 and L2PoA02), switches 1506-1510, CAPWAP AC 1511, SDN/OpenFlow controller 1513, and anchor 1512. It may be assumed that at the start WTRU 1502 is not attached to the network.

WTRU 1502 may arrive at the network and perform a network detection procedure 1514, by actively probing the network. It may be assumed that WTRU 1502 is in radio coverage of two APs 1504, 1505, which may not be sending beacon frames. WTRU 1502 may send several Probe Request frames 1516, also referred to as active probing, which may be received by both AP 1504, 1505. The Probe Requests 1517 may be forwarded to the AC 1511 by the APs 1504, 1505. Probe Requests may be processed by the APs 1504, 1505, which may generate Probe Responses 1522 without waiting for any further command from the AC 1512.

At 1515, the data forwarding path between the APs 1504, 1505 and the AC 1511 for the CAPWAP control and data messages (e.g. UDP, control packets may use AC port 5246, data packets may use AC port 5247) may already be configured in the SDN/OpenFlow network. The data forwarding path between the APs 1504, 1505 and the AC 1511 may also be configured dynamically, with first packets received by the APs 1504, 1505 being forwarded to the SDN/OpenFlow controller 1513.

The AC 1511 may wait a pre-configured amount of time to be able to process all potential Probe Request frames 1516 sent by the same WTRU 1502. At 1518, the AC 1511 may do any of the following: identify the WTRU 1502 based on its MAC address or different out-of-band mechanisms; decide based on different criteria (e.g. the load and/or location of the APs 1504, 1505) which of the APs 1504, 1505 is going to serve the WTRU 1502; and create a virtual WLAN (e.g. SSID=WTRU1-WLAN). In this example, the elements 1522 through 1544 in FIG. 15 behave the same as corresponding elements 1222 through 1244, as described above with respect to FIG. 12, and thus are not repeated here.

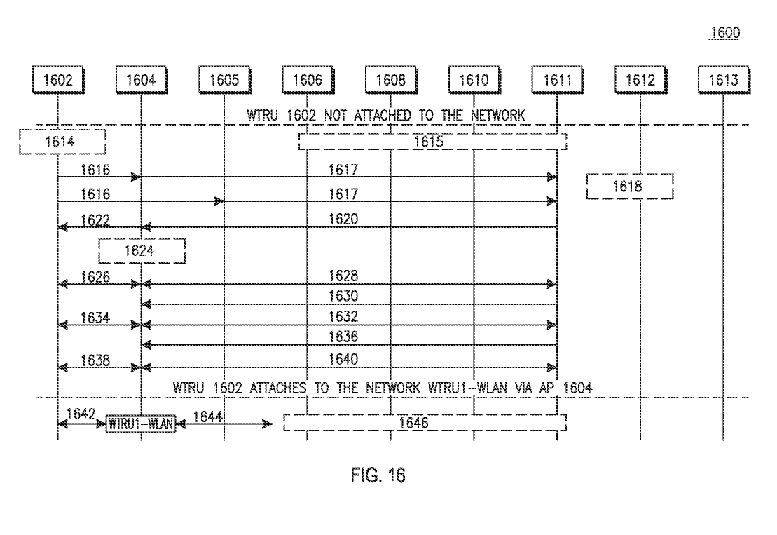

FIG. 16 is a signaling diagram of an example SDN/OpenFlow wireless, local MAC L2 network detection and initial attachment procedure 1600. The example network includes WTRU 1602, WTPs 1604, 1605 (e.g. 802.11 APs and/or CAPWAP WTPs, L2PoA01 and L2PoA02), switches 1606-1610, CAPWAP AC 1611, SDN/OpenFlow controller 1613, and anchor 1612. In this example, the elements 1614 through 1646 in FIG. 16 perform similar operations as corresponding elements 1514 through 1546, as described above with respect to FIG. 15 and are not all repeated here, except for the additional modifications to the original CAPWAP operations described below.

The AC 1611 may transmit another Station Configuration Request message 1636, which may include, but is not limited to, any of the following: an Add Station message element, which may include a Virtual LAN (VLAN) name (e.g. WTRU1 MAC), which when present may be used by the WTP 1604 to identify the VLAN on which the user's data frames are to be bridged; an IEEE 802.11 Add Station message element, which may include the WLAN Identifier (e.g. WTRU1-WLAN) with which the station has associated; an IEEE 802.11 Station Session Key message element (e.g. key=x), which may include the pair wise encryption key; and/or an IEEE 802.11 Information Element message element, which may include the RSNIE to the WTP 1604, and may state the security policy to enforce for the client (e.g. AES-CCMP).

The WTP 1604 may receive IEEE 802.11 Management Action frames 1638 and forward the IEEE 802.11 Management Action frames to the AC 1611. At 1646, the SDN/OpenFlow network may be configured so the WTP 1604 may locally bridge client data frames and may provide the encryption and decryption services. The WTP 1604 may also tunnel client data frames to the AC 1611, using 802.3 frame tunnel mode or 802.11 frame tunnel mode. This is described in further detail below with reference to L3 network discovery and attachment procedures.

L3 network detection and initial attachment procedures are disclosed herein. Once the WTRU is associated to an L2 PoA, the next step may be to obtain IP connectivity, by performing L3 network discovery and/or configuring an IP address and default router. This L3 configuration may follow the WTRU while it moves within the network, so it does not observe any change from its L3 point of view as a result of any handover. Methods for L3 network detection and initial attachment for CAPWAP based architecture, OpenFlow Wireless based architecture, and CAPWAP+SDN/OpenFlow Wireless based architecture are disclosed herein.

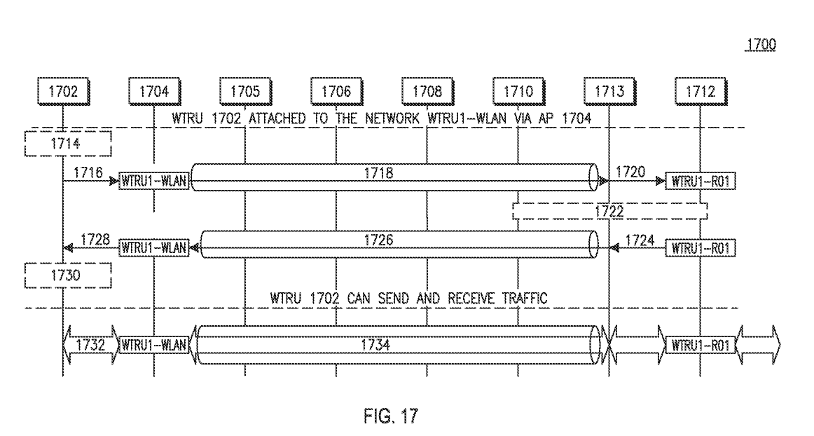

FIG. 17 is a signaling diagram of an example CAPWAP-based, split MAC L3 network detection and initial attachment procedure 1700. The example network includes WTRU 1702, WTPs 1704, 1705, switches 1706-1710, CAPWAP AC 1713 and anchor 1712. In this case, the CAPWAP AC 1713 may implement L3 anchoring functions itself or the anchor role may be played by a different physical network entity, such as anchor 1712. It may be assumed that at the start WTRU 1702 is attached to the network WTRU1-WLAN via AP 1704.

At 1714, WTRU 1702 may search for available IPv6 routers or switches on its link. WTRU 1702 may send an IPv6 Router Solicitation message 1716 to learn how many IPv6 routers are reachable on the link and to obtain IP configuration information. The IPv6 message 1716 may be received by WTP 1704, which may be operating in “split MAC” mode, which means traffic is tunneled between WTP 1704 and AC 1713. More specifically, the WTP 1704 may encapsulate an IEEE 802.11 MAC frame into a CAPWAP frame, removing the frame check sequence, before sending it to the AC 1713.

Thus, AC 1713 receives the IPv6 Router Solicitation frame 1718, as encapsulated by the WTP 1704, from the WTP 1704. The AC 1713 may be configured to perform different actions depending on the type of IEEE 802.11 MAC frame it receives. For example, the AC 1713 may be configured based on local policies or an ad-hoc configuration protocol with another entity. The AC 1713 may check that the received data frame, in this case is an IPv6 Router Solicitation message 1718, came from an associated station (in this case WTRU 1702) and process the L2 payload. The AC may identify the WTRU 1702 as a new WTRU not previously attached at L3 to the network. This may be done, for example, by consulting a logically centralized database, such as the home subscriber server (HSS) (not shown).

At 1722, a new virtual router may be created, for example WTRU1-R01, and may be assigned to WTRU 1702. This may involve allocating an L2 logical address and IPv6 link-local address, as well as allocating an IPv6 prefix to the WTRU 1702 (e.g. PrefWTRU1::/64). The AC 1713 may select the network entity that will play the role of L3 anchor, hosting the virtual router WTRU1-R01, which in this example is anchor 1712. This context/configuration information may be conveyed to anchor 1712 and configured by using a protocol, such as simple network management protocol (SNMP) (e.g. extending/defining anew management information base (MIB)). The forwarding, if any, between the AC 1713 and the selected anchor 1712 may be configured in the network. If the AC 1713 and the anchor 1712 are connected to the same L3 network, then the AC 1713 may encapsulate the received payload to the L2 logical address of WTRU01-R01 for forwarding to the anchor 1712.

The AC 1713 may forward the IPv6 Router Solicitation message 1720 to anchor 1712. The selected anchor 1712 may reply to the Router Solicitation 1720 with a Router Advertisement 1724 that may contain the allocated prefix (e.g. PrefWTRU1::/64) to the WTRU 1702. The AC 1713 forwards the Router Advertisement 1726, and the WTP 1704 in turn forwards Router Advertisement 1728 to WTRU 1702. At 1730, the WTRU 1702 may configure an IPv6 address out of the allocated prefix (e.g. PrefWTRU1::WTRU1/64), as well as a default route via WTRU1-R01, for example. At this point, WTRU 1702 can send and receive IPv6 traffic using the configured IPv6 address.

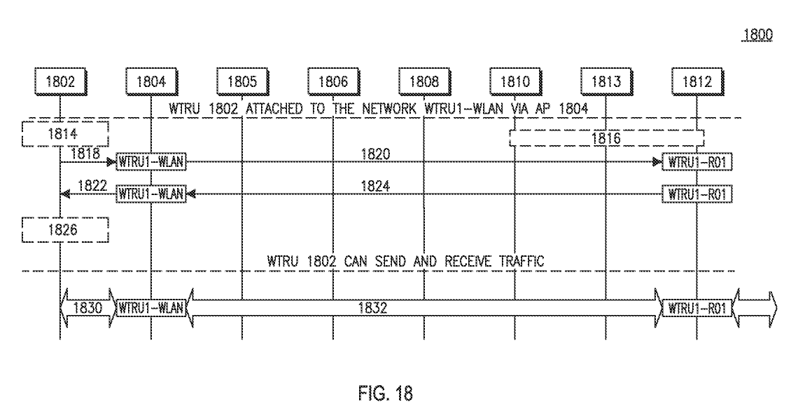

FIG. 18 is a signaling diagram of an example CAPWAP-based, local MAC L3 network detection and initial attachment procedure 1800. The example network includes WTRU 1802, WTPs 1804, 1805, switches 1806-1810, CAPWAP AC 1813 and anchor 1812. In the example of FIG. 18, the WTP 1804 may implement L3 anchoring functions itself, for example if the WTP 1804 has a topologically close breakout point, which would lead to a distributed mobility management (DMM)-like solution. In the example of FIG. 18, it may be assumed that the anchor role is played by a different network entity, in this case anchor 1812. It may also be assumed that at the start WTRU 1802 is attached to the network WTRU1-WLAN via WTP 1804.

Referring to FIG. 18, after looking for available IPv6 routers on the link at 1814, the WTRU 1802 may send an IPv6 Router Solicitation message 1818 to learn how many IPv6 routers are reachable on the link and to obtain IP configuration information. The IPv6 Router Solicitation message 1818 may be received by WTP 1804, which may be operating in “local MAC” mode, which means it may be in charge of processing and forwarding the IPv6 Router Solicitation message 1820 (an L2 frame) to the anchor 1812.

In order to support the virtual network, the network may realize that WTRU 1802 has first attached to the network. This may be done, for example, by consulting a centralized data base, such as the HSS (not shown), and creating a new “virtual router” to be allocated to WTRU 1802. At 1816, the new “virtual router” may be created, (e.g. WTRU1-R01), and may be assigned to WTRU 1802. This may involve allocating an L2 logical address and/or IPv6 link-local address, as well as allocating an IPv6 prefix (e.g. PrefWTRU1::/64) to the WTRU 1802.

A network entity, in this example anchor 1812, may be selected to play the role of L3 anchor, and thus may host the virtual router WTRU1-R01. WTP 1804 may know and/or decide which “virtual router” is allocated to WTRU 1802, and the associated information may extend CAPWAP signaling to allow this information to be conveyed at L2 attachment.

Additionally, and as in the split MAC mode, the virtual network WTRU1-R01 context/configuration information may also be conveyed to anchor 1812 and configured. This may be done by using a dedicated protocol or existing ones, such as SNMP, by extending and/or defining a new MIB, for example. If the anchor functionality is collocated with the WTP function, then CAPWAP extensions may be used. The forwarding, if any, between the WTP 1804 and the selected anchor 1812 may be configured in the network. If the WTP 1804 and the anchor 1812 are connected to the same L3 network, the received payload may be encapsulated to the L2 logical address of WTRU1-R01.

The selected anchor 1812 may reply to the Router Solicitation message 1820 with a Router Advertisement message 1824, which may contain the allocated prefix (e.g. PrefWTRU1::/64), to the WTP 1804, which may forward the Router Solicitation message 1822 to the WTRU 1802. At 1826, the WTRU 1802 may configure an IPv6 address out of the allocated prefix, PrefWTRU1::WTRU1/64, as well as a default route via WTRU1-R01. At this point, WTRU 1802 may send and receive IPv6 traffic 1830 and 1832 using the configured IPv6 address.

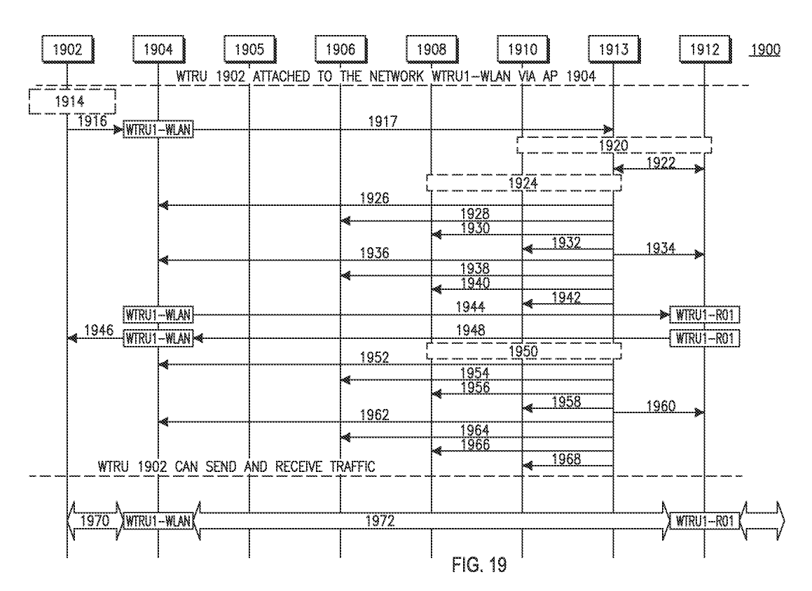

FIG. 19 is a signaling diagram of an example SDN/OpenFlow Wireless L3 network detection and initial attachment procedure 1900. The example network includes WTRU 1902, WTPs 1904, 1905, switches 1906-1910, SDN/OpenFlow controller 1913 and anchor 1912. It may be assumed that at the start WTRU 1902 is attached to the network WTRU1-WLAN via AP 1904.

Referring to FIG. 19, after looking for available IPv6 routers on the link at 1914, WTRU 1902 may send an IPv6 Router Solicitation message 1916 to learn how many IPv6 routers are reachable on the link and to obtain IP configuration information. The IPv6 Router Solicitation message 1918 may be received by an SDN/OpenFlow enabled AP 1904. Without a flow matching rule, the the IPv6 Router Solicitation message 1917 may be forwarded to the SDN controller 1913.

The SDN controller 1913 may analyze the received IPv6 Router Solicitation message 1917 and may check if it is an initial attachment of WTRU 1902 to the network. This may be done, for example, by consulting a centralized data base, such as the HSS or similar (not shown). If it is an initial attachment of WTRU 1902 to the network, at 1920 the SDN controller 1913 may create a new “virtual router” to be allocated to WTRU 1902 (e.g. WTRU1-R01), and assigned to WTRU 1902. This may involve allocating an L2 logical address and IPv6 link-local address, as well as allocating an IPv6 prefix to the WTRU 1902 (e.g. PrefWTRU1::/64).

The network entity may be selected that will play the role of L3 anchor, in this case anchor 1912, and host the virtual router WTRU1-R01. At 1922, the SDN controller 1913 may know/decide which “virtual router” is allocated to WTRU 1902, and the associated information, by reusing some IPv6 configuration protocol or defining a new one. At 1924, the SDN controller 1913 may configure the data forwarding plane between the L2 attachment point, AP 104, and the L3 selected anchor 1912. The SDN controller 1913 may send Add Flow messages 1926, 1928, 1930, 1932, 1934, 1936, 1938, 1940, and 1942 to configure the data forwarding path by adding new routing flow to each switch 1906-1910 on the path. For example, this data forwarding path may be for internet control message protocol version 6 (ICMPv6) Router and Neighbor Discovery messages.

The IPv6 Router Solicitation message 1944 may be forwarded and delivered from WTRU1-WLAN (on AP 1904) to WTRU1-R01 (on anchor 1912), which may reply with a Router Advertisement message 1948 containing for example the allocated prefix (e.g. PrefWTRU1::/64) to WTRU-WLAN (on AP 1904), which may forward Router Advertisement message 1946 to the WTRU 1902. WTRU 1902 may configure an IPv6 address out of the allocated prefix, PrefWTRU1::WTRU1/64, as well as a default route via WTRU1-R01. At 1950, the SDN controller may configure the data forwarding plane between the L2 attachment point, AP 1904, and the L3 selected anchor 1912, such hat allow IPv6 data packets may be delivered. The SDN controller 1913 may send Add Flow messages 1952, 1954, 1956, 1958, 1960, 1962, 1964, 1966, and 1968 to configure the data forwarding path by adding new routing flow to each switch 1906-1910 on the path. At this point, WTRU 1902 may send and receive IPv6 traffic 1970 and 1972 using the configured IPv6 address.

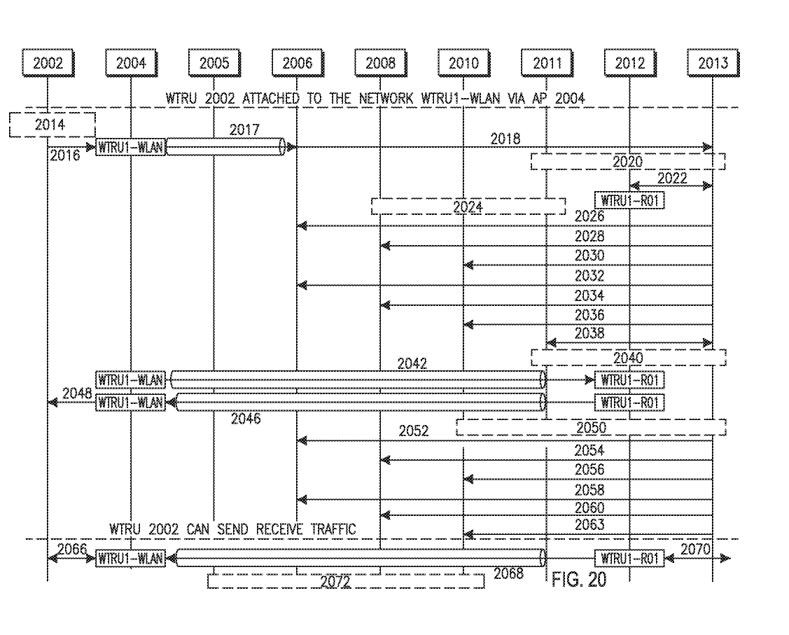

FIG. 20 is a signaling diagram of an example CAPWAP+SDN/OpenFlow Wireless, split MAC L3 network detection and initial attachment procedure 2000. The example network includes WTRU 2002, WTPs 2004, 2005, switches 2006-2010, CAPWAP AC 2011, SDN/OpenFlow controller 2013 and anchor 2012. It may be assumed that at the start WTRU 2002 is attached to the network WTRU1-WLAN via AP 2004.

Referring to FIG. 20, after looking for available IPv6 routers on the link at 2014, WTRU 2002 may send an IPv6 Router Solicitation message 2016 to learn how many IPv6 routers are reachable on the link and to obtain IP configuration information. The IPv6 message 2016 may be received by WTP 2004, which may locally forward the IPv6 message 2017 to switch 2006 (WTP 2004 may be connected to switch 2006).

Without a flow matching rule, the frame 2018 containing the IPv6 Router Advertisement 2017, and possibly other data, may be forwarded by switch 2006 to the SDN controller 2013. The SDN controller 2013 may analyze the frame 2018 and determines that there is an IPv6 Router Solicitation 2017 encapsulated in a CAPWAP frame 2018. The SDN controller 2013 may analyze the Router Solicitation message 2017 and may determine if it is from an initial attachment of WTRU 2002 to the network. This may be done, for example, by consulting a centralized data base, such as the HSS or similar (not shown).

If the Router Solicitation message 2017 is determined to be from an initial attachment of WTRU 2002 to the network, at 2020 the SDN controller 2013 may create a new “virtual router” (e.g., WTRU1-R01) to be allocated to WTRU 2002 and assigned to WTRU 2003. This may involve allocating an L2 logical address and IPv6 link-local address, as well as allocating an IPv6 prefix (e.g. PrefWTRU1::/64) to the WTRU 2002.

A network entity may be selected that will play the role of L3 anchor, in this case anchor 2012, which may host the virtual router WTRU1-R01. At 2022 the SDN controller 2013 may know/decide which “virtual router” is allocated to WTRU 2002, and the associated information, by reusing some IPv6 configuration protocol or defining a new one. At 2024, the SDN controller 2013 may configure the data forwarding plane between the CAPWAP WTP 2004 and the CAPWAP AC 2011, for the tunneled packets, including setting up the rules for CAPWAP tunneled packets, (e.g. UDP destination, local port on the AC: 5247, carrying ICMPv6 packets). The SDN controller 2013 may send Add Flow messages 2026, 2028, 2030, 2032, 2034, and 2036 to configure the data forwarding path by adding new routing flow to each switch 2006-2010 on the path. If there is an SDN/OpenFlow capable network between CAPWAP AC 2011 and anchor 2012, the SDN controller 2013 may also configure the forwarding plane in order to route traffic between WTRU 2002 and the selected L3 anchor 2012.

At 2038, the CAPWAP AC 2011 may be configured to know that the Router Solicitation 2042 and, in general, any IPv6 router and neighbor discovery signaling from WTRU 2004 should be forwarded to WTRU1-R01 located at anchor 2012. This may be realized in different ways, for example by re-using OpenFlow protocol messages. At 2040, if there is an (SDN/OpenFlow) capable network between the CAPWAP AC 2011 and the selected L3 anchor 2012, the forwarding path may be programmed to allow the IPv6 packets to reach the L3 anchor 2012.

The encapsulated IPv6 Router Solicitation 2042 may be forwarded to the CAPWAP AC 2011. The AC 2011 may receive the frame 2042, de-encapsulate it, and forward it to WTRU1-R01 located on anchor 2012. The AC 2011 may be configured to perform different actions depending on the type of IEEE 802.11 MAC frame 2042. The AC may be configured based on local policies or an ad-hoc configuration protocol with another entity.

The IPv6 Router Solicitation 2042 may be forwarded to the selected anchor 2012, which may reply with a Router Advertisement message 2046 that may contain the allocated prefix, PrefWTRU1::/64, to the WTP 2004, which forwards the Router Advertisement message 2048 to the WTRU 2002. WTRU 2002 may configure an IPv6 address out of the allocated prefix, PrefWTRU1::WTRU1/64, as well as a default route via WTRU1-R01. At 2050, the SDN controller may configure the data forwarding plane between the CAPWAP WTP 2004 and the CAPWAP AC 2011, for the tunneled IPv6 data packets. The SDN controller 2013 may send Add Flow messages 2052, 2054, 2056, 2058, 2060, and 2062 to configure the data forwarding path by adding new routing flow to each switch 2006-2010 on the path. This may involve setting up the rules for CAPWAP tunneled packets, (e.g. UDP destination, local port on the AC: 5247, carrying IPv6 packets). Finer granularity may be used, for example, by looking inside the encapsulated packets or at additional information carried in the CAPWAP packet.

At this point, WTRU 2002 may send and receive IPv6 traffic using the configured IPv6 address (e.g. PrefWTRU1::WTRU1). Between WTP 2004 and the AC 2011, data traffic 2066 from the WTRU 2002 may be encapsulated into message 2068, according to a “split MAC” model, which may be forwarded from the AC 2011 to the L3 selected anchor 2012, with or without using a tunnel. The message 2070 may be further forwarded on from the anchor 2012 to the controller 2013.

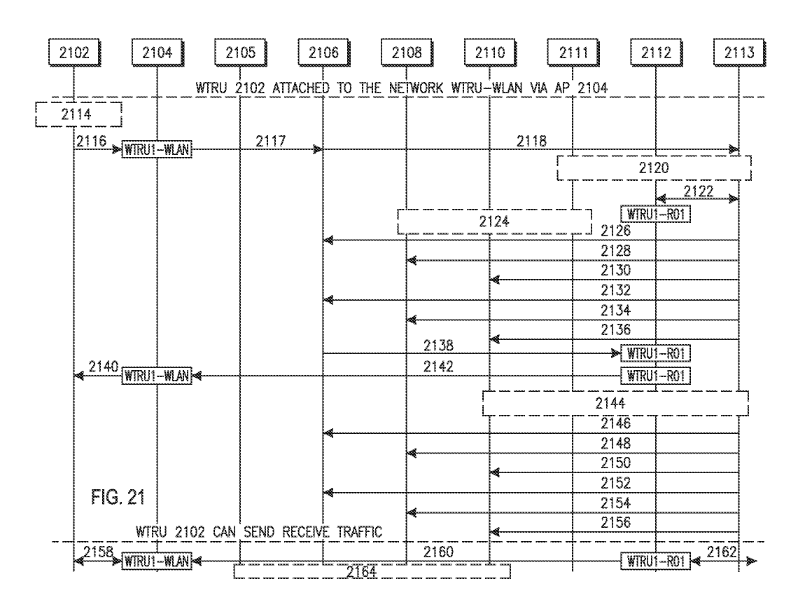

FIG. 21 is a signaling diagram of an example CAPWAP+SDN/OpenFlow Wireless, local MAC L3 network detection and initial attachment procedure 2100. The example network includes WTRU 2102, WTPs 2104, 2105, switches 2106-2110, CAPWAP AC 2111, SDN/OpenFlow controller 2113 and anchor 2112. It may be assumed that at the start WTRU 2102 is attached to the network WTRU1-WLAN via AP 2104.

Referring to FIG. 21, after looking for available IPv6 routers on the link at 2114, WTRU 2102 may send an IPv6 Router Solicitation message 2116 to learn how many IPv6 routers are reachable on the link and to obtain IP configuration information. The IPv6 message 2116 may be received by WTP 2104, which may locally forward the IPv6 message 2117 to switch 2106 (WTP 2104 may be connected to switch 2106).

Without a flow matching rule, the frame 2118 containing the IPv6 Router Solicitation 2117, and possibly other data, may be forwarded by switch 2106 to the SDN controller 2113. The SDN controller 2113 may analyze the received frame 2118 and check if it is an initial attachment of WTRU 2102 to the network. This may be done, for example, by consulting a centralized data base, such as the HSS or similar (not shown). If the received frame 2118 is an initial attachment of WTRU 2102 to the network, at 2120 the SDN controller 2113 may create a new “virtual router” logical entity (e.g. WTRU1-R01) to be allocated to WTRU 2102. This may involve allocating an L2 logical address and IPv6 link-local address, as well as allocating an IPv6 prefix (e.g. PrefWTRU1::/64), to the WTRU 2102. At 2122 the virtual router information may be exchanged with the anchor 2112.

A network entity, in this case anchor 2112, may be selected that will play the role of L3 anchor to host the virtual router WTRU1-R01. The SDN controller 2113 may know/decide which “virtual router” is allocated to WTRU 2102, and the associated information, by reusing some IPv6 configuration protocol or defining a new one. At 2124, the SDN controller 2113 may configure the data forwarding plane between the switch 2106 and the L3 selected anchor 2112, over which ICMPv6 Router and Neighbor Discovery messages may be delivered, for example. The SDN controller 2113 may send Add Flow messages 2126-2136 to configure the data forwarding path by adding new routing flow to each switch 2106-2110 on the path.

The IPv6 Router Solicitation 2138 may now forwarded and delivered to WTRU1-R01 located on anchor 2112, which may reply with a Router Advertisement 2142 containing the allocated prefix, PrefWTRU1::/64, to the WTP 2104, and onto the WTRU 2102 via Router Advertisement message 2140. WTRU 2102 may configure an IPv6 address out of the allocated prefix, PrefWTRU1::WTRU1/64, as well as a default route via WTRU1-R01. At 2144, the SDN controller 2113 may configure the data forwarding plane/path between the L2 attachment point, WTP 2104, and the L3 selected anchor 2112, allowing IPv6 data packets to be delivered. The SDN controller 2113 may send Add Flow messages 2146-2156 to configure the data forwarding path by adding new routing flow to each switch 2106-2110 on the path. At this point, WTRU 2102 may send and receive IPv6 traffic using the configured IPv6 address (e.g. PrefWTRU1::WTRU1).

Between WTP 2104 and the AC 2111, data traffic 2158 from the WTRU 2102 may be forwarded or encapsulated into message 2160 to virtual network WTRU1-R01 at anchor 2112, which may be forwarded to the SDN controller 2013, with or without using a tunnel. At 2164, the data forwarding path between WTRU 2102 and AC 2111 may be configured on a finer grain, for example based on characteristics of the WTRU 2102, such as its signal quality

Considerations for finer forwarding policies using SDN/OpenFlow are disclosed herein. The programming of the data forwarding plane within the SDN/OpenFlow network for WTRU's traffic may be done on a finer granularity. This would allow, for example, traffic to be forwarded differently depending on, but not limited to, the following: the WTRU, the radio signal quality perceived by the WTRU, the application running on the WTRU, and/or the SSID. Even the same WTRU may have traffic split among different paths, for example for different applications. This may be done by installing SDN/OpenFlow matching rules according to the CAPWAP IEEE 802.11 data encapsulation format.

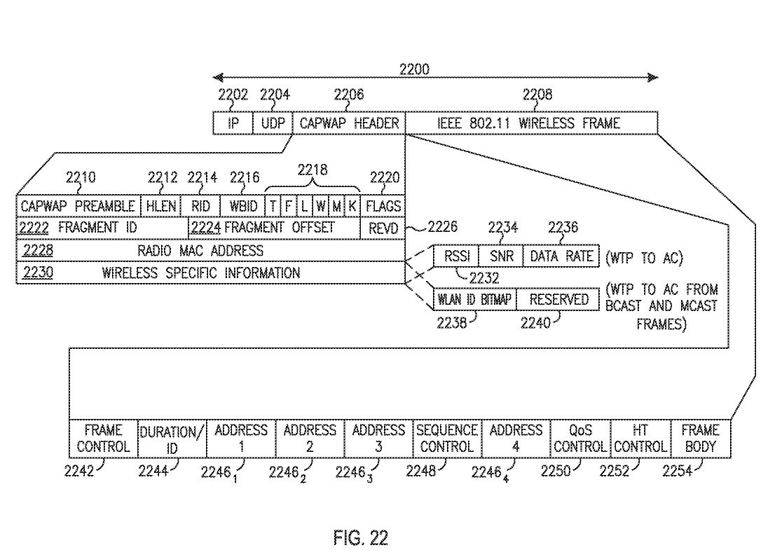

FIG. 22 is diagram of an example CAPWAP message 2200 following a CAPWAP Institute of Electrical and Electronics Engineers (IEEE) 802.11 data encapsulation format. CAPWAP message 2200 may include, but is not limited to, an IP header 2202, a UDP header 2204, a CAPWAP header 2206, and a payload including IEEE 802.11 wireless frame 2208. For CAPWAP message 2200, a plain text encapsulation may be used, as per RFC 5415 for example.

The IEEE 802.11 wireless frame 2208 may include, but is not limited to, any of the following fields: frame control 2242, duration and/or ID field 2244, address fields 2246_{1 . . . 4}, sequence control field 2248, quality of service (QoS) control field 2250, high throughput (HT) control field 2252, and/or frame body 2254. The CAPWAP header 2206 may include, but is not limited to, any of the following fields: CAPWAP preamble field 2210, HLEN field 2212, RID 2214, WBID 2216, bits 2218, flags 2220, fragment ID field 2222, fragment offset field 2224, reserved field 2226, radio MAC address field 2228, and/or wireless specific information field 2230.

In the case of a CAPWAP frame 2200 being transmitted from a WTP to an AC, the wireless specific information 2230 may include, but is not limited, any of the following fields: RSSI 2232, SNR 2234, and/or data rate 2236. In the case of a CAPWAP frame 2200 being transmitted from an AC to WTP, for broadcast or multicast frames for example, the wireless specific information 2230 may include, but is not limited, any of the following fields: WLAN ID bitmap 2238, and/or reserved field 2240.

CAPWAP, in its binding format for IEEE 802.11, may specify an encapsulation format used between the WTP and the AC. While in “local MAC” mode, encapsulation is used for only the initial control frames, whereas in the “split MAC” mode, all L2 data frames may be encapsulated to the AC. The encapsulated frame is the whole IEEE 802.11 frame, excluding the FCS, and may include all the MAC addresses. CAPWAP may also include meta-information that may be added to the forwarded frames. This information may include, for example, the received signal strength indication (RSSI) and signal-to-noise ratio (SNR) of the frames received by the WTP. This additional information may be used when taking data forwarding programming decisions, if the SDN/OpenFlow protocol supported it. Some of this information may not be present in a transmitted over-the-air IEEE 802.11 frame, such as the RSSI/SNR, but may be added by the driver. For example, some information may be provided by what is locally included in the radio TAP headers and/or the CAPWAP message.

The “split MAC” mode may allow for the forwarding path to be dynamically updated, taking into consideration the information conveyed on the CAPWAP header of the encapsulated data frames. The “local MAC” mode may also allow some dynamic programming by considering at least the initial information on the WTRU status (e.g., initial signal quality), which may be derived from the first control frames exchanged by the WTRU and the WTP and encapsulated towards the AC.

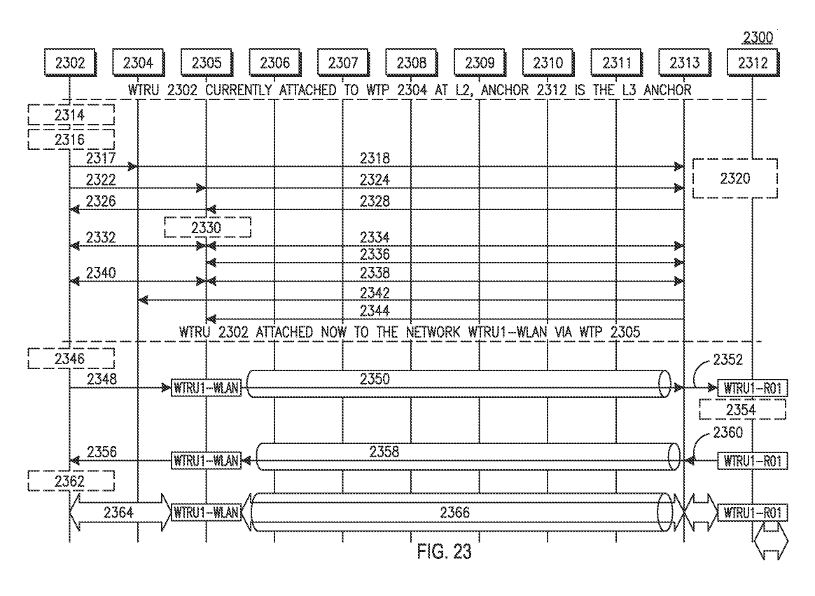

Methods for intra-domain handover for CAPWAP based architecture, SDN/OpenFlow Wireless based architecture, and CAPWAP+SDN/OpenFlow Wireless based architecture are disclosed herein. FIG. 23 is a signaling diagram of an example CAPWAP, split MAC intra-domain handover procedure 2300. The example network includes WTRU 2302, WTPs 2304, 2305, switches 2306-2311, CAPWAP AC 2313, and anchor 2312. It may be assumed that at the start WTRU 2302 is attached WTP 2304 at L2, and anchor 2312 is the L3 anchor.

In this scenario, WTRU 2302 is already attached to the network, via WTP 2304, but at 2314 the signal quality it perceives is getting low, so at 2316 WTRU 2302 begins looking for additional APs (WTPs), for example WTP 2305. This may include the WTRU 2302 actively scan searching for available 802.11 networks and for more APs from the same ESS (e.g. WTRU1-WLAN). It may be possible to force a handover from the network side, for example by configuring WTP 2304 not to reply to the periodic Probe Request typically sent by IEEE 802.11 stations.

Referring to FIG. 23, WTRU 2302 may send Probe Request frame (e.g. with SSID=WTRU1-WLAN or wildcard SSID) 2317 to the original attachment point WTP 2304 and send Probe Request frame 2322 to the new attachment point WTP 2305. Both frames 2318 and 2324 may be forwarded to the AC 2313.

At 2320, after receiving both Probe Request frames 2318 and 2324, the CAPWAP AC 2313 may decide to replicate the virtual WLAN (e.g., SSID=WTRU1-WLAN) on WTP 2305, so that WTRU 2302 can roam there. The decision to do so might be based, for example, on the SNR and RSSI values encapsulated together with the Probe Request frames 2318 received via WTP 2304 and Probe requests 2322 and 2324 from WTP 2305. At 2328, the AC 2313 may send an IEEE 802.11 Add WLAN primitive to WTP 2305 indicating any of the following: SSID=WTRU1-WLAN, split-MAC, and/or other parameters. At 2330, a virtual WLAN with SSID=WTRU1-WLAN is created on WTP 2305, which may send a probe response (e.g. with SSID=WTRU1-WLAN) to the WTRU 2302.

If WTRU 2302 decides to roam to WTP 2305, IEEE 802.11 signaling may take place as in the L2 detection and initial attachment, for example. At 2338, the AC 2313 may remove the configuration for the virtual WLAN network at WTP 2304 once WTRU 2302 has re-associated to WTP 2305. This may be done via a Station Configuration Request message 2338, which may indicate to delete station identified by WTRU1 MAC, for example. The WTP 2305 may go through an 802.11 authentication and/or association procedure 2332 and 2334, and 802.1X Authentication Key Exchange 2338 and 2340, similar to the corresponding actions described in FIG. 12 above. Additionally, the AC 2313 may send a Station Configuration Request 2336 to WTP 2305 (e.g. to add station and set session key), and another Station Configuration Request 2344 to WTP 2305 (e.g. to add station and set session key), similar to the corresponding actions described in FIG. 12 above. A this point, the WTRU 2302 may be attached to the network WTRU1-WLAN via WTP 2305.

While the virtual WLAN, SSID=WTRU1-WLAN, is replicated reactively upon scanning from the WTRU 2302 as shown in the example of FIG. 23, it is also possible to preconfigure it on some neighbors so it is faster. This may come at the cost of additional signaling and state on the nodes.

In the example provided in FIG. 23, it is assumed that no new L3 anchor is selected. Thus, the same anchor and IP prefix(es) (e.g. PrefWTRU1::/64) may be allocated to WTRU 2305 when the virtual network WTRU1-WLAN is hosted on WTP 2305. If this case, a DMM approach may be followed, and therefore no additional signaling procedures are needed. At 2346, periodic IPv6 router and neighbor solicitation signaling may be sent by WTRU 2302, and may reach the virtual L3 router WTRU1-R01 hosted at anchor 2312 via the CAPWAP AC 2313.

Since no programmable network is assumed to be used in the example, proper L2/L3 forwarding between WTP 2304 or WTP 2305 and the AC 2313, and also between the AC 2313 and anchor 2312, may be assumed to be in place. Note that this scenario is similar to Proxy Mobile IPv6, but following an L2 approach, instead of an L3 approach. WTRU 2302 may send IPv6 Router Solication 2348 to network WTRU1-WLAN on WTP 2305, which may in turn forward Router Advertisement 2350 to CAPWAP AC 2313, and onto anchor 2312 via message 2352. Anchor 2312 may respond with Router Advertisement 2360, via CAPWAP AC 2313 which forwards Router Advertisement message 2358 to the WTP 2305, which may forward the Router Advertisement 2356 to the WTRU 2302.

At 2362, the WTRU 2302 may continue to use the same IPv6 address (e.g. PrefWTRU1::WTRU1/64) and default route via WTRU1-R01 hosted on anchor 2312, for data traffic 2364 from the WTRU 2302 to WTP 2305, and data traffic 2366 from WTP 2305 to AC 2313 (e.g. PrefWTRU1::WTRU1).

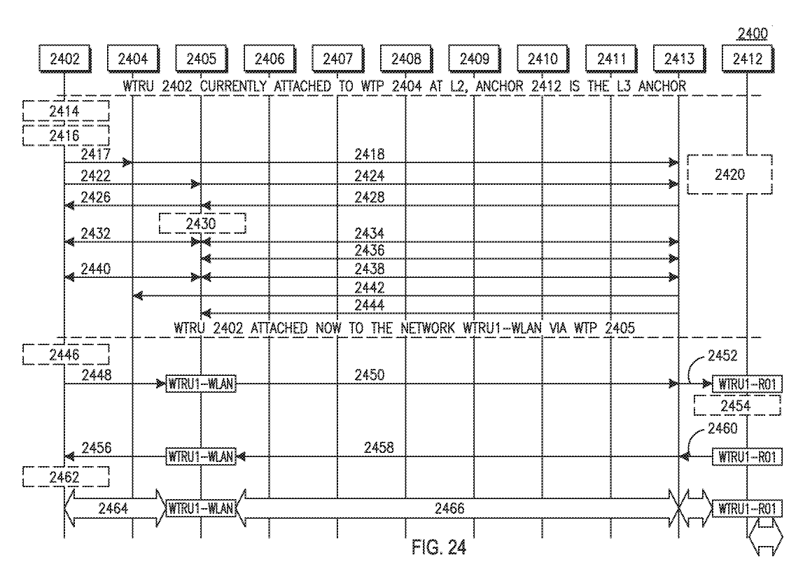

FIG. 24 is a signaling diagram of an example CAPWAP, local MAC intra-domain handover procedure 2400. The example network includes WTRU 2402, WTPs 2404, 2405, switches 2406-2411, CAPWAP AC 2413, and anchor 2412. It may be assumed that at the start WTRU 2402 is attached WTP 2404 at L2, and anchor 2412 is the L3 anchor. The elements 2414 through 2442, and 2446 through 2466 in FIG. 14 behave the same as corresponding elements 2314 through 2342 and 2346 through 2366 as described above with respect to FIG. 23, and thus are not repeated here, except for the differences described below.

In scenario of FIG. 24, the process is almost analogous to the scenario of FIG. 23, with one difference being that there may be no tunnel for the data traffic 2366 between the WTP 2405 and the AC 2413. Also, the Station Configuration Request message 2444 sent by AC 2413 may have different parameters (than message 2344 in FIG. 23), which may include: an Add Station message element that may include a Virtual LAN (VLAN) name (e.g. WTRU1 MAC), which when present may be used by the WTP 2402 to identify the VLAN on which the user's data frames 2464 are to be bridged; an IEEE 802.11 Add Station message element, which may include the WLAN Identifier with which the WTRU 2402 has associated (e.g. WTRU1-WLAN); an IEEE 802.11 Station Session Key message element, which may include the pair wise encryption key (e.g. key=x); and/or an IEEE 802.11 Information Element message element, which may include the RSNIE to the WTP 1304, stating the security policy to enforce for the client (e.g. AES-CCMP).

Once WTP 2405 is configured for WTRU 2402, the WTP 2405 may be configured so it knows which network entity is hosting the L3 virtual anchor (i.e. anchor 2412) for WTRU 2402, so it can forward both IPv6 control and data packets. This may be done with a separate protocol, either a new one to be defined or re-using existing ones (e.g. PMIPv6 approach).

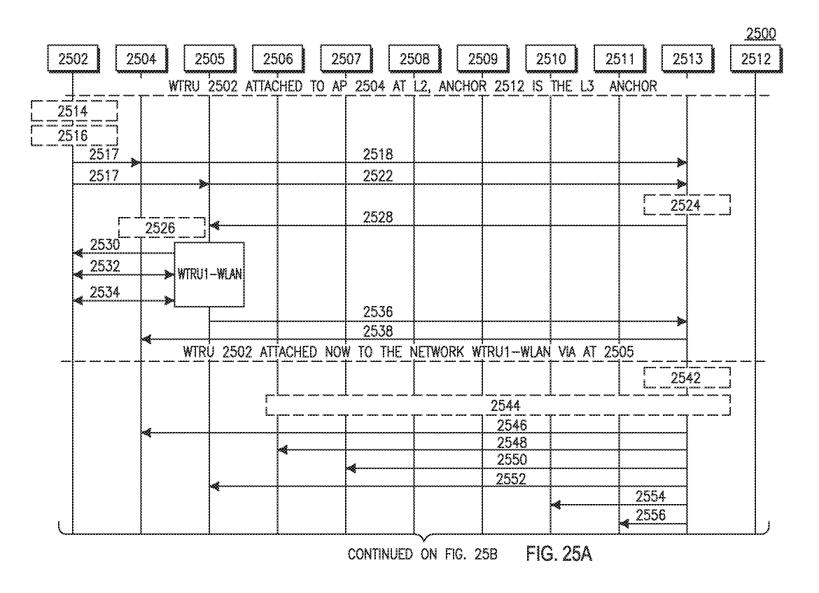

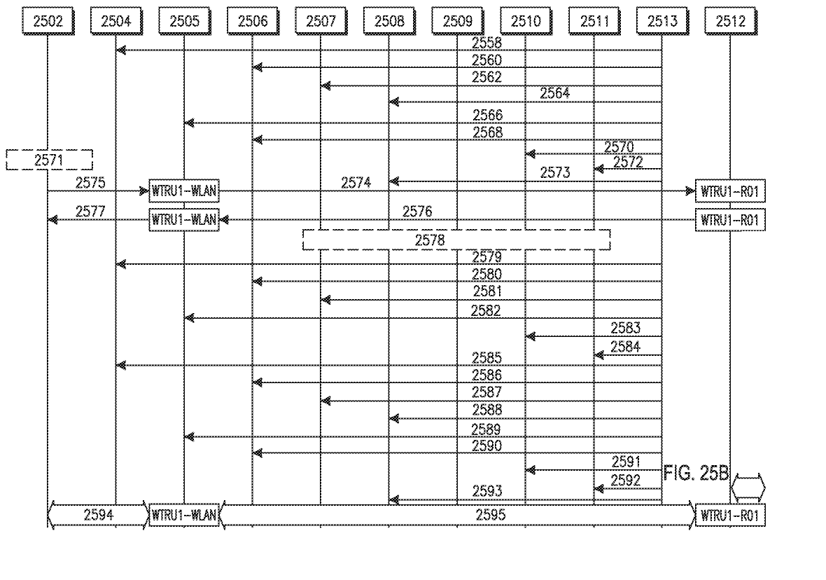

Methods for intra-domain handover for SDN/OpenFlow Wireless based architecture are disclosed herein. FIGS. 25A and 25B are a signaling diagram of an example SDN/OpenFlow Wireless intra-domain handover procedure 2500. The example network includes WTRU 2502, APs 2504, 2505, switches 2506-2511, SDN/OpenFlow controller 2513, and anchor 2512. It may be assumed that at the start WTRU 2502 is attached AP 2504 at L2, and anchor 2512 is the L3 anchor.

WTRU 2502 is already attached to the network, via AP 2504, but at 2514 the signal quality the WTRU 2502 perceives is getting low, so WTRU 2502 may begin looking for additional APs at 2516, following scan searching procedures described in previous example. As in previous examples, it may also be possible to force a handover from the network side, for example, by configuring AP 2504 not to reply to the periodic Probe Requests 2517 sent by IEEE 802.11 stations such as WTRU 2502.

WTRU 2502 may send Probe Requests frames 2517, which may be received by the access points in coverage, APs 2504 and 2505 in this example. One or both APs 2504 and 2505 may forward these Probe Request frames 2518 and 2522, respectively, to the SDN/OpenFlow controller 2513. For example, only AP 2505, to which the WTRU 2502 is not currently attached, may forward the Probe Request frames 2522.

At 2524, the SDN controller 2513 may decide to replicate the virtual WLAN (e.g., SSID=WTRU1-WLAN) on WTP 2505, using OF-Config signaling 2528 for example, so that WTRU 2502 can move there. This may be motivated by the state of the network. At 2526, a virtual WLAN may be created at AP 2505 with the same SSID=WTRU1-WLAN. AP 2505 may send a Probe Response message 2530 (indicating WTRU1-WLAN) to the WTRU 2502, and the WTRU02 may decide to move AP 2505.

After the IEEE 802.11 re-association signaling 2532 and 802.1X authentication and 802.11 Key Exchange signaling 2543 has been completed, the AP 2505 may send an attachment notification event 2536 to the SDN/OpenFlow controller 2513. If this event notification 2536 is not present, the network may rely on IPv6 router and neighbor discovery, like the base mechanism defined by Proxy Mobile IPv6. The SDN/OpenFlow controller 2513 may send an OF-Config message 2538 to the AP 2502 to remove the virtual WLAN instance at AP 2504 (although this may also be done based on timer expiration), and to update the data path forwarding within the network. The OF-Config message 2538 may include, but is not limited, to a remove WLAN indication, SSID=WTRU1-WLAN, and/or additional information.

At 2542, the same anchor and IP prefix(es), PrefWTRU1::/64, is allocated to WTRU 2502. At 2544 and 2578, the SDN/OpenFlow controller 2513 may update the data forwarding path in the network, so ICMPv6 and IPv6 traffic can be delivered between WTRU 2502 and virtual network WTRU1-R01 while WTRU 2502 is attached at its new location, 2505. The SDN controller 2513 may send Remove Flow messages 2546, 2548, 2550, 2558, 2560, 2562, 2564, 2579, 2580, 2581, 2585, 2586, 2587, and 2588 to remove flow from each network entity on the original data-plane routing path; and Add Flow messages 2552, 2554, 2556, 2566, 2568, 2570, 2572, 2573, 2582, 2583, 2584, 2589, 2590, 2591, 2592, and 2593 to add flow to each network entity on the new data-plane routing path.

At 2571, WTRU 2502 may perform periodic router and neighbor discovery. For example, WTRU 2502 may send out IPv6 Router Solicitation message 2574/2575, which may be forwarded to anchor 2512. Anchor 2512 may respond with Router Advertisement message 2576/2577, which may be forwarded to WTRU 2502. From the point of view of WTRU 2502, nothing has changed at L2 nor at L3. At 2594 and 2595, WTRU 2502 may continue sending and receiving traffic using the IPv6 configured address (e.g. SSID=WTRU1-WLAN).

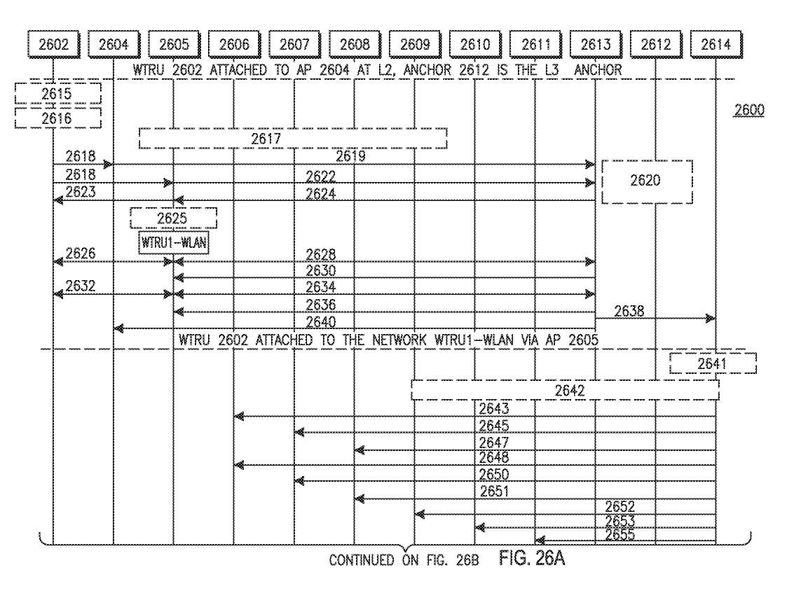

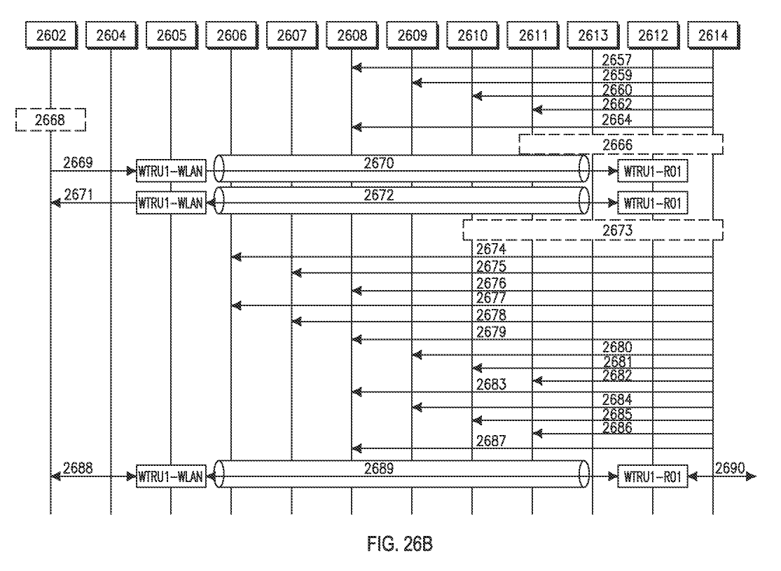

Methods for intra-domain handover for CAPWAP+SDN/OpenFlow Wireless based architecture are disclosed herein. FIGS. 26A and 26B are a signaling diagram on an example CAPWAP+SDN/OpenFlow Wireless, split MAC, intra-domain handover procedure 2600. The example network includes WTRU 2602, APs 2604, 2605, switches 2606-2611, CAPWAP AC 2613, SDN/OpenFlow controller 2613, and anchor 2612. It may be assumed that at the start WTRU 2602 is attached WTP 2604 at L2, and anchor 2612 is the L3 anchor.

At 2615 the WTRU 2602 may observe that the signal quality it perceives is getting low, so WTRU 2602 may begin looking for additional APs at 2616 (using active scan search for example). As in previous examples, it may also be possible to force a handover from the network side, by for example configuring WTP 2604 not to reply to the periodic Probe Request 2623 sent by IEEE 802.11 stations.

WTRU 2604 may send Probe Requests frames 2618, which may be received by the access points in coverage, which are WTP 2604 and WTP 2605 in this example. WTP 2604 and WTP 2605 may forward Probe Requests frames 2619 and 2622, respectively, to the CAPWAP AC 2613. At 2620, the AC 2613 may decide to replicate the virtual WLAN (e.g., SSID=WTRU1-WLAN) on WTP 2605, so that WTRU 2602 can move there. This decision may be motivated by the state of the network or the signal quality perceived from WTP 2604 by WTRU 2602. It may also involve coordination with the SDN/OpenFlow controller 2614, to provide support on the WTRU 2602.

The CAPWAP AC 2613 may send an Add WLAN message 2624 to the WTP 2605 to create, at 2625, the virtual WLAN with SSID=WTRU1-WLAN on WTP 2605. WTP 2605 may also send a Probe Response 2623 to the WTRU 2602, so that the WTRU 1602 may decide to move to WTP 2605.

IEEE 802.11 signaling for the WTRU 2602 to attach to WTP 2605 and re-associate to virtual network WTRU1-WLAN may include 802.11 authorization/association signaling 2626 and 2628, Station Configuration Request messages 2630 and 2636, and 802.1X authentication and 802.11 key exchange 2632 and 2634, which behave like the signaling described in previous examples such as in FIG. 12 and FIG. 23.

The CAPWAP AC 2613 may notify the SDN/OpenFlow controller 2614 of the L2 handover event via attachment event notification 2638. The CAPWAP AC 2613 may also send a Delete WLAN message 2640 (e.g. including SSID=WTRU1-WLAN, split-MAC, and additional parameters) to the previous accces point WTP 2604, which may proceed to remove the virtual WLAN network, though this could also be done based on timer expiration, for example if pre-provision of the virtual WLAN on several neighboring WTPs was considered. This event notification 2638 may use signaling not defined by CAPWAP or OpenFlow. Without the event notification 2638, the reception of a data packet from WTRU 2602 not matching an existing rule, such as a Router Solicitation, may be used to trigger the procedure. As a result of the above, the WTRU 2602 is attached to the virtual network WTRU1-WLAN via WTP 2605.

Triggered by the L2 handover event notification 2638, at 2641 the SDN/OpenFlow controller 2614 may evaluate if a new anchor needs to be assigned to WTRU 2602 or if the same anchor 2612 and IP prefix(es) (e.g. PrefWTRU1::/64) may be allocated to WTRU 2602.

In this example, the same anchor 2612 is selected, and at 2642 and 2673 the data forwarding path is updated in the network for both IPv6 router and neighbor discovery messages and for IPv6 messages between WTP 2605 and the CAPWAP AC 2613. The SDN controller 2613 may send Remove Flow messages 2643, 2645, 2647, 2648, 2650, 2651, 2674, 2675, 2676, 2677, 2678, and 2679 to remove flow from each network entity on the original data-plane routing path. The SDN controller 2513 may send Add Flow messages 2652, 2653, 2655, 2657, 2659, 2660, 2662, 2664, 2680, 2681, 2682, 2683, 2684, 2685, 2686, and 2687 to add flow to each network entity on the new data-plane routing path. At 2668, WTRU 2602 may perform periodic router and neighbor discovery. For example, WTRU 2602 may send out IPv6 Router Solicitation message 2669/2670, which may be forwarded to anchor 2612. The anchor 2612 may respond with Router Advertisement message 2671/2672, which may be forwarded to WTRU 2602. From the point of view of WTRU 2602, nothing has changed at L2 or at L3. WTRU 2602 may continue sending and receiving data traffic 2688, 2689 and 2690 using the IPv6 configured address.

A CAPWAP+SDN/OpenFlow Wireless, local MAC intra-domain handover procedure may be similar to the procedure 2600 in FIGS. 26A and 26B. The CAPWAP “local MAC” mode may be similar to the CAPWAP “split MAC” mode shown in FIGS. 26A and 26B, including similar operations to elements 2615 through 2690 as described above with respect to FIGS. 26A and 26B. However, a difference in the “local MAC” mode may be that data traffic 2689, and similarly router solicitations and router advertisements, may be communicated directly between WTPs and the selected anchor, without being encapsulated to the CAPWAP AC.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in an Institute of Electrical and Electronics Engineers (IEEE) 802.11 controller comprising:
creating a virtual network for a wireless transmit/receive unit (WTRU) in response to an event associated with the WTRU;
assigning a context-specific Service Set Identification (SSID) associated with the virtual network to the WTRU;
configuring at least one of a plurality of switches and routers so that the WTRU has a context-specific virtual router and a designated routing path to the context-specific virtual router; and
reconfiguring at least one of the plurality of switches and routers for the WTRU in response to a detected change in the virtual network.

2. The method of claim 1, wherein the configuring at least one of the plurality of switches and routers uses a control plane configuration protocol independent from a data plane protocol.

3. The method of claim 2, wherein the control plane configuration protocol is a control and provisioning of wireless access points (CAPWAP) protocol.

4. The method of claim 2, wherein the control plane configuration protocol is an OpenFlow Management and Configuration Protocol (OF-Config).

5. The method of claim 1, wherein the event associated with the WTRU is mobility of the WTRU.

6. The method of claim 1, wherein the event associated with the WTRU is the WTRU connecting to the network.

7. The method of claim 1, wherein the context-specific SSID is an SSID dedicated to the WTRU.

8. The method of claim 1, further comprising:
selecting a first physical access point (AP) to serve the virtual network; and
sending an Add wireless local area network (WLAN) primitive to the first physical AP.

9. The method of claim 8, wherein the change in the virtual network is the WTRU moving from the first physical AP to a second physical AP.

10. The method of claim 9, wherein the WTRU moving from the first physical AP to the second physical AP is triggered by a signal quality from the first physical AP falling below a pre-determined threshold.

11. An Institute of Electrical and Electronics Engineers (IEEE) 802.11 controller comprising:
the IEEE 802.11 controller configured to create a virtual network for a wireless transmit/receive unit (WTRU) in response to an event associated with the WTRU;
the IEEE 802.11 controller configured to assign a context-specific Service Set Identification (SSID) associated with the virtual network to the WTRU;
the IEEE 802.11 controller configured to configure at least one of a plurality of switches and routers so that the WTRU has a context-specific virtual router and a designated routing path to the context-specific virtual router; and
the IEEE 802.11 controller configured to reconfigure at least one of the plurality of switches and routers for the WTRU in response to a detected change in the created virtual network.

12. The IEEE 802.11 controller of claim 11, wherein the IEEE 802.11 controller is configured to configure at least one of the plurality of switches and routers using a control plane configuration protocol independent from a data plane protocol.

13. The IEEE 802.11 controller of claim 12, wherein the control plane configuration protocol is a control and provisioning of wireless access points (CAPWAP) protocol.

14. The IEEE 802.11 controller of claim 12, wherein the control plane configuration protocol is an OpenFlow Management and Configuration Protocol (OF-Config).

15. The IEEE 802.11 controller of claim 11, wherein the event associated with the WTRU is mobility of the WTRU.

16. The IEEE 802.11 controller of claim 11, wherein the event associated with the WTRU is the WTRU connecting to the network.

17. The IEEE 802.11 controller of claim 11, wherein the context-specific SSID is an SSID dedicated to the WTRU.

18. The IEEE 802.11 controller of claim 11, wherein:
the IEEE 802.11 controller is configured to select a first physical access point (AP) to serve the virtual network; and
the IEEE 802.11 controller is configured to send an Add wireless local area network (WLAN) primitive to the first physical AP.

19. The IEEE 802.11 controller of claim 18, wherein the change in the virtual network is the WTRU moving from the first physical AP to a second physical AP.

20. The IEEE 802.11 controller of claim 19, wherein the WTRU moving from the first physical AP to the second physical AP is triggered by a signal quality from the first physical AP falling below a pre-determined threshold.
